(19) United States
(12) Patent Application Publication
(10) Pub. No.: US 2026/0286101 A1
(43) Pub. Date: Sep. 24, 2026

(54) METHODS AND ADDITIVES TO IMPROVE PERFORMANCE OF CARBON PARTICLES IN ELASTOMER COMPOSITES

(71) Applicant: Monolith Materials, Inc., Lincoln, NE (US)

(72) Inventors: Mason McCormick, Lincoln, NE (US); Joshua Abell, St. Louis, MO (US); Lucas Wilke, Lincoln, NE (US); Connor Adams, Lincoln, NE (US); Ned Hardman, Spring, TX (US)

(73) Assignee: Monolith Materials, Inc., Lincoln, NE (US)

(21) Appl. No.: 19/571,291

(22) Filed: Mar. 18, 2026

Related U.S. Application Data
(60) Provisional application No. 63/774,017, filed on Mar. 18, 2025.

(51) Int. Cl. C08K 9/04; C09C 1/48; C09C 1/58; C09C 3/00; C09C 3/04; C09C 3/06; C09C 3/08

(52) U.S. Cl. CPC C08K 9/04; C09C 1/485; C09C 1/58; C09C 3/006; C09C 3/045; C09C 3/06; C09C 3/08; C01P 2004/80; C01P 2006/80

(57) ABSTRACT

Water soluble sulfur active molecules of the present disclosure distributed on the surface of carbon particles and/or pellets (including but not limited to plasma pyrolysis carbon black) increase performance of the carbon particles and/or pellets in rubber compounds and vulcanizates, for example by increasing the modulus at 300% elongation (M300) over conventional carbon black without largely detrimental effects on scorch.

### CROSS-REFERENCE

This application is related to and claims the benefit of priority under 35 U.S.C. § 119(e) from U.S. Provisional Patent Application No. 63/774,017, filed Mar. 18, 2025, which is incorporated by reference herein in its entirety.

### BACKGROUND

The use of carbon black in elastomer compounds has been a long-standing practice in the production of rubber articles, such as tires, hoses, and belts. Carbon black serves as a reinforcing filler, providing improved strength, durability, and abrasion resistance to the elastomer compound. However, the performance of carbon black in elastomer compounds can vary significantly depending on the type of carbon black used, its surface chemistry, and the presence of other additives.

### SUMMARY

Recognized herein is a need for the methods and additives of the present disclosure to enhance the performance of carbon particles (e.g., carbon black) in the reinforcement of rubber and other elastomeric compounds. For example, there is a need to enhance the performance of carbon particles (e.g., plasma carbon black) in the reinforcement of elastomers, elastomer compounds, vulcanizates, and/or rubber articles, including by increasing elastic modulus (e.g., M300) to meet or improve material properties compared to conventional furnace carbon black, without largely detrimental effects on scorch.

In an aspect, a carbon black pellet includes carbon particles decorated with one or more water soluble sulfur active species after the carbon particles are degassed.

In some embodiments, the carbon particles are decorated at, in, or after a pelletizer.

In some embodiments, the one or more water soluble sulfur active species has (i) a water solubility greater than or equal to about 20 grams per liter (g/L) and (ii) at least one carbon atom, at least one hydrogen atom, and at least one sulfur atom in a molecule.

In some embodiments, compounding the carbon black pellet with an elastomer into an elastomer compound increases a modulus at 300% elongation (M300) or a ratio of a modulus at 300% elongation to a modulus at 100% elongation (M300/M100) of the elastomer compound by at least about 5% compared to a reference M300 or a reference M300/M100, respectively, of a reference elastomer compound, wherein the reference elastomer compound contains a reference carbon black pellet of a same preparation except without decorating carbon particles of the reference carbon black pellet with the one or more water soluble sulfur active species.

In some embodiments, levels of the one or more water soluble sulfur active species on the decorated carbon particles are between 0.05% and 1% by mass.

In some embodiments, sulfur levels on the decorated carbon particles are less than or equal to 1% by mass.

In some embodiments, the one or more water soluble sulfur active species includes a dithiocarbamate, a thiocarbamate, a xanthate, a thiourea, a thiocarbamide, a thiuram, a functionalized lignosulfonate, a sodium mercaptobenzothiazole, 5-amino-2-mercaptobenzimidazole or its related compounds, or any combination thereof.

In some embodiments, the one or more water soluble sulfur active species includes the dithiocarbamate.

In some embodiments, the dithiocarbamate is sodium diethyldithiocarbamate.

In some embodiments, the one or more water soluble sulfur active species includes the xanthate.

In some embodiments, the one or more water soluble sulfur active species includes the functionalized lignosulfonate.

In some embodiments, before the carbon particles are degassed, the carbon particles are generated in a plasma process.

In some embodiments, the carbon black pellet surface is further decorated with elemental sulfur supplied in colloidal form.

In some embodiments, the carbon particles are decorated with a cure retarder, an amine, or both, with or in addition to the one or more water soluble sulfur active species after the carbon particles are degassed.

In some embodiments, a hydrophilic spreading pressure of the carbon particles is increased by at least 10% upon decoration with the one or more water soluble sulfur active species.

In an aspect, a composite includes an elastomer and the carbon black pellet.

In an aspect, a method includes adding, after degassing and before a dryer, one or more water soluble sulfur active species to carbon black particles to form the carbon black pellet.

In an aspect, treated carbon particles have on their surface a water soluble sulfur active species such that, when the treated carbon particles are compounded with an elastomer into an elastomer compound, the elastomer compound has a modulus at 300% elongation (M300) that is higher than a reference M300 of a reference elastomer compound, by a value greater than ten (10) times a percentage loading of the water soluble sulfur active species on the treated carbon particles, wherein the reference elastomer compound includes reference carbon particles that are of a same preparation as the treated carbon particles except the reference carbon particles have no water soluble sulfur active species on a surface thereof.

In some embodiments, an oxygen level on the surface of the treated carbon particles is less than 0.5% by mass, a nitrogen level on the surface of the treated carbon particles is less than 0.09% by mass, a hydrogen level on the surface of the treated carbon particles is less than 0.25% by mass, and/or a sulfur level on the surface of the treated carbon particles is less than 0.5% by mass.

In some embodiments, the elastomer compound has a scorch time (TS1) that is lower than a reference TS1 of the reference elastomer compound, by a value greater than or equal to thirty (30) times the percentage loading of the water soluble sulfur active species on the treated carbon particles.

In some embodiments, scorch times (TS1 and TS2) of the elastomer compound including the treated carbon particles are decreased by more than 10% but less than 40% compared to the reference elastomer compound.

In some embodiments, scorch times (TS1 and TS2) of the elastomer compound including the treated carbon particles have been tuned to match a furnace black while simultaneously matching an M300 of the furnace black.

In some embodiments, a loading of the water soluble sulfur active species is between 0.05% and 0.5% by mass.

In some embodiments, the treated carbon particles further include elemental sulfur on the surface thereof.

In an aspect, a method includes compounding an elastomer with a carbon black, a surface of which has a water soluble sulfur active species dispersed thereupon.

In an aspect, an elastomer compound includes the carbon black surface with the water soluble sulfur active species dispersed thereupon, wherein the water soluble sulfur active species includes one or more of a mercaptobenzothiazole, a sulfenamide, a mercaptobenzothiazole sulfenamide, a thiuram, and a diphenylguanidine.

In an aspect, a carbon black includes a water soluble sulfur active species dispersed on a surface of the carbon black, wherein, upon incorporation of the carbon black into an elastomer compound, scorch times (TS1 and TS2) of the elastomer compound do not decrease by more than 10% on either value over a baseline elastomer compound having a baseline carbon black surface with no water soluble sulfur active species dispersed thereupon.

In an aspect, a method for improving a carbon particle for use in an elastomer compound includes: (a) reacting a liquid hydrocarbon mixture with carbon disulfide (CS₂), wherein the liquid hydrocarbon mixture (i) has an average molecular weight of at least 150 g/mol and (ii) includes one or more polycyclic aromatic hydrocarbons (PAHs) functionalized with oxygen, nitrogen, or both in an individual or combined concentration of at least 0.5% by weight; (b) thereby generating a dithiocarbamate or a xanthate; and (c) decorating a surface of the carbon particle with one or more of the dithiocarbamate or the xanthate.

In some embodiments, the liquid hydrocarbon mixture includes one or more of carbon black oil (CBO), aminopyrene, or alcohol-functionalized pyrene.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative, and not restrictive.

### BRIEF DESCRIPTION OF THE DRAWINGS

Certain features of the inventions of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings (also “Figure” and “FIG.” herein), of which:

FIG. 1 shows a schematic representation of an example method for producing a carbon black pellet, treated carbon particles, and/or carbon black according to one or more embodiments of the present disclosure;

FIG. 2 shows a schematic representation of an example system that can be used to provide a carbon particle (see FIG. 1, item 110) according to one or more embodiments of the present disclosure; and

FIG. 3 shows a schematic representation of an example of a plasma reactor that can be used to provide a carbon particle (see FIG. 1, item 110) according to one or more embodiments of the present disclosure.

### DETAILED DESCRIPTION

While various embodiments of the present disclosure are shown and described herein, those skilled in the art will understand that such embodiments are provided by way of example only. Numerous variations, changes, and substitutions may occur to those skilled in the art without departing from the present disclosure. It should be understood that various alternatives to the embodiments described herein may be employed.

Whenever the term “at least,” “greater than,” or “greater than or equal to” precedes the first numerical value in a series of two or more numerical values, the term “at least,” “greater than,” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within one or more than one standard deviation, per the practice in the art. Alternatively, “about” may mean a range of up to 20%, up to 10%, up to 5%, or up to 1% variation with respect to a given value. Where particular values are set forth herein, unless otherwise stated, it may be assumed that the term “about” means within an acceptable error range for the particular value.

Recognized herein is a need for the methods and additives of the present disclosure to enhance the performance of carbon particles (e.g., carbon black) in the reinforcement of rubber and other elastomeric compounds. The term “carbon black,” as used herein, may refer to carbon particles produced by various chemical processes that have evolved over time (e.g., from simple flame, to oil furnace, to plasma pyrolysis, etc.), including any of furnace black, plasma carbon black, acetylene black, thermal black, lamp black, or channel black. The term “furnace carbon black” or “furnace black” refers to carbon black produced by a furnace process. The term “plasma pyrolysis carbon black” or “plasma carbon black” refers to carbon particles produced by a plasma pyrolysis process.

As a large proportion of produced carbon particles (e.g., greater than about 85% of the world's produced carbon black) is used for the reinforcement of elastomers (e.g., rubber articles including tires, hoses, belts, gaskets, weather stripping, and the like), carbon particle performance in elastomeric reinforcement can be an important if not critical property. However, plasma produced carbon black may demonstrate decreased elastomeric reinforcement ability versus carbon blacks produced by other methods. As in all manufacturing, there is a need for more efficient and effective production methods, for new and improved products, and for improved performance in elastomer composites.

The methods and additives of the present disclosure can improve properties of plasma pyrolysis produced carbon particles compared to furnace produced (or other conventionally produced) carbon particles or can be used to improve properties of furnace produced (or other conventionally produced) carbon particles.

It is known that carbon disulfide (CS₂) is created as a byproduct during the production of carbon black using a conventional furnace black process, likely due to sulfur impurities in the hydrocarbon feedstock (e.g., pyrolysis fuel oil (PFO), tire pyrolysis oil (TPO), and/or carbon black oil (CBO)). It is also known that nitrogen functionality exists at the surface of furnace carbon black due to injection of air into the combustion process, and that CS₂ reacts with nitrogen-containing secondary amines (R₂NH) to rapidly form dithiocarbamates (R₂N—C(═S)—S—R). This reaction mechanism and the inherent presence of such dithiocarbamates at the surface of furnace produced carbon particles could explain why furnace carbon black reinforces so well in rubber articles, providing exceptional performance over other conventional carbon black types such as acetylene black and channel black.

In the furnace process, while the presence of nitrogen in the burner air can lead to formation of secondary amines and dithiocarbamates on the surface of furnace carbon black, environmentally hazardous nitrogen oxides (NOx) may be released into the atmosphere due to the nitrogen at high temperatures. And while the presence of sulfur in the feedstock is advantageous for elastomer reinforcement, the furnace process releases hazardous sulfur oxides (SOx) into the atmosphere. In contrast, the plasma pyrolysis process avoids combustion and thus emissions associated with the furnace process. In particular, environmental benefits of using plasma pyrolysis to produce carbon particles include substantially lower carbon dioxide (CO₂) emissions (oxygen-free atmosphere and lack of combustion), nitrogen oxide (NOx) emissions (no air injection into the process), and sulfur oxide (SOx) emissions (non-sulfurous feedstock or sulfur scrubbing post-process), as well as co-production of hydrogen.

Heretofore, it has not been realized that dithiocarbamates and the like that naturally form on the surface of a furnace carbon black particle could be at least partially responsible for the increased reinforcement of furnace carbon black, that such water soluble sulfur active accelerators can be added to a carbon black surface to change or improve certain properties not inherent in the sample, and/or how to effect the addition. A non-limiting example of where the water soluble sulfur active molecules can be purposefully added is at the pelletizer, as described further below, to realize an advantageous increase in reinforcement properties when included in elastomeric compositions (or elastomer compounds) for rubber articles.

Conventionally, accelerators (i.e., chemical additives that speed up the elastomer (e.g., rubber) curing process) encompass many different classes of compounds. These conventional accelerators generally are grouped into the following four classes:
1. Thiazole—mercaptobenzothiazole (MBT), dibenzothiazyl disulfide (MBTS), zinc mercaptobenzothiazole (ZMBT), sodium mercaptobenzothiazole (NaMBT), mercaptobenzothiazole sulfenamide (or derivatives), etc.
2. Sulfenamide—N-cyclohexylbenzothiazole-2-sulfenamide (CBS), N-tert-butylbenzothiazole-2-sulfenamide (TBBS), N-oxydiethylenebenzothiazole-2-sulfenamide (MBS), N—N′-dicyclohexylbenzothiazole-2-sulfenamide (DCBS), etc.
3. Thiuram—tetramethylthiuram monosulfide (TMTM), tetramethylthiuram disulfide (TMTD), tetraethylthiuram disulfide (TETD), tetrabenzylthiuram disulfide (TBzTD), dipentylthiuram tetrasulfide (DPTT), etc.
4. Dithiocarbamate—zinc dimethyldithiocarbamate (ZDMC), zinc diethyldithiocarbamate (ZDEC), zinc dibutyldithiocarbamate (ZDBC), zinc dibenzyldithiocarbamate (ZBzDC or ZBEC) etc.
   However, only some of these derivatives (and/or their ammonium salts) may offer increased water solubility; many are water insoluble.

Previous explorations of water soluble additives that failed to identify the improvements or methodologies disclosed herein include, for example, U.S. Pat. No. 9,175,150 (surface modifying furnace carbon black using diazonium reaction to attach amino version of triazole, pyrazole, and/or imidazole onto the carbon black, i.e. covalent chemistry, to increase strength in an elastomeric composition); Westenberg, Surface Modified Carbon Black for Modern Low Rolling Resistance Tires—Compounding Strategy and Process Optimization, Paper #C23 (American Chemical Society, Rubber Division, Technical Meeting, Oct. 8-10, 2019, ISSN: 1547-1977) (surface modifying furnace carbon black through oxidation and then adding water insoluble aminophenyl disulfide to increase performance); Combs et al., New approach to coupling functionalized carbon black, Rubber & Plastics News, Apr. 16, 2018 (considering several factors and selecting Rhenocure SDT/S, a phosphoryl polysulfide accelerator, as a coupling agent for oxidized carbon black), each of the foregoing incorporated by reference herein. In contrast, plasma pyrolysis carbon black is not oxygenated (i.e., possesses minimal to no oxygen), the additives of the present disclosure are both water soluble and sulfur active, and diazonium chemistry is not present in a plasma pyrolysis process, underscoring the substantially different process and resulting surface chemistries of plasma carbon black and furnace black.

Carbon black (e.g., plasma pyrolysis carbon black) can be produced in an anaerobic atmosphere that is substantially free of oxygen or at least 95%, 96%, 97%, 98%, 99% or more non-oxygen. The non-oxygen atmosphere may be comprised of hydrogen, nitrogen, argon, krypton, and/or other non-oxygen gases, and/or carbon monoxide (CO), which is stable to high temperatures in a low molecular oxygen environment. If oxygen is present and the temperature is sufficient, the CO will react to form carbon dioxide (CO₂), but in the absence of molecular oxygen, CO can be a beneficial plasma gas. See, for example, co-owned Int. Pat. Pub. No. WO 2023/235486, incorporated by reference herein.

Carbon black produced from low sulfur feedstock in a plasma pyrolysis process in the substantial absence of oxygen or nitrogen (e.g., less than 5%, 4%, 3%, 2%, or 1% of either) will have a low amount of sulfur, oxygen, or nitrogen content by volume. See, for example, co-owned U.S. Pat. No. 11,760,884, incorporated by reference herein. Indeed, plasma pyrolysis carbon black differs from furnace carbon black in that plasma pyrolysis carbon black has (1) decreased surface activity, (2) decreased surface hydrogen content, (3) increased crystallite size in the bulk and at the surface, (4) decreased surface defects (e.g., Stone-Wales defects), (5) decreased number of high energy sites, (6) decreased oxygen, nitrogen, and/or sulfur content, and/or (7) decreased polycyclic aromatic hydrocarbons (PAH) content. These substantial technical differences, absent the present disclosure, reasonably would lead to the conclusion that plasma pyrolysis carbon black would lack the beneficial surface properties to interact strongly with the elastomer matrix, commonly known as the polymer-filler interaction, in rubber manufacturing. A measure of this interaction is the modulus at 300% elongation (M300), as well as the ratio of the modulus at 300% elongation to the modulus at 100% elongation (M300/M100), both of these measured using the stress-strain curve of a rubber specimen.

However, the present inventors have discovered that the water soluble and elastomer insoluble sulfur active molecules of the present disclosure increase the performance of plasma pyrolysis carbon black by an appreciable amount, for example by an increase in M300 over conventional carbon black without largely detrimental effects on scorch.

Accelerators may be used in carbon particle (e.g., carbon black) production to help control vulcanization and optimize properties of elastomeric composites (or elastomer compounds) used in tire treads and other rubber articles in which the carbon black provides reinforcement. Adding accelerators to the carbon particle surface typically reduces scorch time or increases reversion, where: “scorch” refers to unwanted premature vulcanization (crosslinking) of a rubber compound, causing it to cure (or harden) too soon, often leading to reduced performance of material properties; “scorch time” refers to the initial period during which the rubber compound can be processed at a given temperature before it begins to vulcanize prematurely (partially cross-link before reaching optimum cure time), characterized by an early rise in torque on a rheometer curve and often defined as the time required for an increase of 1 (TS1) or 2 (TS2) points above a minimum torque; and “reversion” describes a decrease in cross-link density and performance of mechanical properties (e.g., softening) after the optimum cure time has passed.

There is a long-standing need to increase performance of carbon black, including without limitation the performance of plasma carbon black in rubber. And it is useful to be able to add agents to increase performance in rubber, for non-limiting example at the carbon black pelletizer as the binder is delivered in an aqueous solution.

In embodiments, the agent that is added to the carbon black, such as before, at, in, or after the pelletizer (after the degas and before the dryer), is a water soluble sulfur active species. Water soluble sulfur active species of the present disclosure may comprise accelerators, although not all water soluble accelerators will qualify. The water soluble sulfur active species of the present disclosure must be water soluble (e.g., greater than or equal to about 20 grams of solute per liter of solvent (g/L)) and possess a minimum of one carbon atom, one hydrogen atom, and one sulfur atom in a molecule, and may activate the carbon black surface by increasing M300 or M300/M100 by at least about 5%.

The hydrocarbon feedstock may include any chemical with formula CₙHₓ or CₙHₓO_{y}, where: n is an integer; x is between (i) 1 and 2n+2 or (ii) less than 1 for fuels such as coal, coal tar, pyrolysis fuel oils, and the like; and y is between 0 and n. The hydrocarbon feedstock may include, for example, simple or linear hydrocarbons (e.g., methane, ethane, propane, butane, etc.), cyclic hydrocarbons (e.g., cyclopropane, cyclobutene, cyclopentane, cyclohexane, etc.), aromatic feedstocks (e.g., benzene, toluene, ethylbenzene, xylene, naphthalene, methyl naphthalene, pyrolysis fuel oil (PFO), tire pyrolysis oil (TPO), carbon black oil (CBO), coal tar, coal, heavy oil, oil, bio-oil, bio-diesel, other biologically derived hydrocarbons, etc.), unsaturated hydrocarbons (e.g., ethylene, propylene, acetylene, butadiene, styrene, etc.), oxygenated hydrocarbons (e.g., alcohols, ethanol, methanol, propanol, phenol, ketones, ethers, esters, carboxylic acids, anhydrides, etc.), or the like, or any combination thereof. The hydrocarbon feedstock may comprise or be natural gas. Sustainable hydrocarbon feedstocks can also be used, for example, feedstocks sourced from bio-matter or comprising at least 10% biological matter that contain a substantial amount of carbon-14 (C14) compared to fossil fuels (e.g., C14:C12 ratios of at least 1.35*10⁻¹⁴). Examples of sustainable feedstocks include renewable natural gas generated from landfills, raw sewage, manure, livestock, or other sources, and feedstocks generated from the pyrolysis of end of life tires in the form of a gaseous hydrocarbon mixture, a liquid hydrocarbon mixture, and/or a carbonaceous solid. Other sustainable hydrocarbon feedstocks that do not contain C14 include processed end of life plastics that can be used to generate aliphatic and aromatic hydrocarbons suitable for use in gas or liquid form. These examples are provided as non-limiting examples of acceptable hydrocarbon feedstocks which may be further combined or mixed with other components for manufacture. These non-limiting examples of acceptable feedstocks need only have a hydrocarbon component (i.e., need not be 100% or even majority hydrocarbon) and may be further combined and/or mixed with other components, including, for example, to ensure an amount of sustainable hydrocarbon feedstock is used in the thermal plasma process.

A hydrocarbon feedstock may refer to a feedstock in which the majority of the feedstock (e.g., more than about 50% by mass) is hydrocarbon (e.g., hydrocarbon and/or hydrocarbon derivative) in nature. The hydrocarbon feedstock may comprise any one or more, or a plurality, of hydrocarbon and/or hydrocarbon derivative and/or hydrocarbon mixture (“Hydrocarbon”) materials. The hydrocarbon feedstock may comprise at least about 1, 2, 3, 4, 5, 6, 7, 8, 9, 10, 20, 30, 40, 50, 60, 70, 80, 90, 100, 120, 140, 160, 180, 200, 220, 240, 260, 280, 300, 350, 400, 450, 500, or more different Hydrocarbon materials as described above. The hydrocarbon feedstock may comprise at most about 500, 450, 400, 350, 300, 280, 260, 240, 220, 200, 180, 160, 140, 120, 100, 90, 80, 70, 60, 50, 40, 30, 20, 10, 9, 8, 7, 6, 5, 4, 3, 2, or 1 different Hydrocarbon materials as described above. The hydrocarbon feedstock may comprise at least about 5, 10, 15, 20, 25, 30, 35, 40, 45, 50, 55, 60, 65, 70, 75, 80, 85, 90, 95, 96, 97, 98, 99, 99.9, or more percent by mass of a single Hydrocarbon material as described above. The hydrocarbon feedstock may comprise at most about 99.9, 98, 97, 96, 95, 90, 85, 80, 75, 70, 65, 60, 55, 50, 45, 40, 35, 30, 25, 20, 15, 10, 5, or less percent by mass of a single Hydrocarbon material as described above. The hydrocarbon feedstock may be or comprise a gas (e.g., natural gas, renewable natural gas, etc.), a liquid (e.g., toluene, tire pyrolysis oil, carbon black oil, sulfur-scrubbed carbon black oil, etc.), or a combination of phases. The hydrocarbon feedstock may have a molecular weight of at least about 16, 20, 25, 30, 35, 40, 45, 50, 60, 70, 80, 90, 100, 200, 300, 400, 500, 600, 700, 800, 900, 1,000, 1,200, 1,400, 1,600, 1,800, 2,000, 2,500, 3,000, 3,500, 4,000, 4,500, 5,000, 6,000, 7,000, 8,000, 9,000, 10,000, or more g/mol. The hydrocarbon feedstock may have a molecular weight of at most about 10,000, 9,000, 8,000, 7,000, 6,000, 5,000, 4,500, 4,000, 3,500, 3,000, 2,500, 2,000, 1,800, 1,600, 1,400, 1,200, 1,000, 900, 800, 700, 600, 500, 400, 300, 200, 100, 90, 80, 70, 60, 50, 45, 40, 35, 30, 25, 20, or 16 g/mol. The molecular weight may be within a range defined by any two of the preceding values. For example, the molecular weight of the hydrocarbon feedstock may be in a range of about 16 to 30 g/mol, 16 to 50 g/mol, 50 to 500 g/mol, 90 to 10,000 g/mol, 500 to 1,000 g/mol, etc.

An input gas to a plasma pyrolysis system may include, but is not limited to, hydrogen, nitrogen, carbon monoxide (CO), carbon dioxide, argon, krypton, neon, methane, or any combination thereof. A gas supply system may provide a non-hydrogenous gas, hydrogen gas, or both to the reactor prior to injection of a hydrocarbon feedstock. In an example, the non-hydrogenous gas or hydrogen gas may be provided to the reactor either through plasma generating electrodes or adjacent to plasma generating electrodes to permit generation of the plasma. The electrodes may have one or more fluid flow pathways that permit the non-hydrogenous or hydrogen gas to flow through the electrode(s). The non-hydrogenous gas (e.g., nitrogen, argon, CO, etc.) may be usable to generate a plasma, and the plasma may be usable to heat the reactor. The gas supply system may provide a hydrocarbon feedstock to the system. The hydrocarbon feedstock may be provided with the non-hydrogenous or hydrogen gas or separate from the non-hydrogenous or hydrogen gas.

Any description of heating a gas or of heating one or more gases herein may equally apply to heating a gaseous mixture (e.g., at least 50% by volume gaseous) with a corresponding composition at least in some configurations. The gaseous mixture may comprise, for example, a mixture of individual gases, liquids, or a mixture of individual gas-liquid mixtures. Any description of a gas herein may equally apply to a liquid or a gas-liquid mixture with a corresponding composition at least in some configurations.

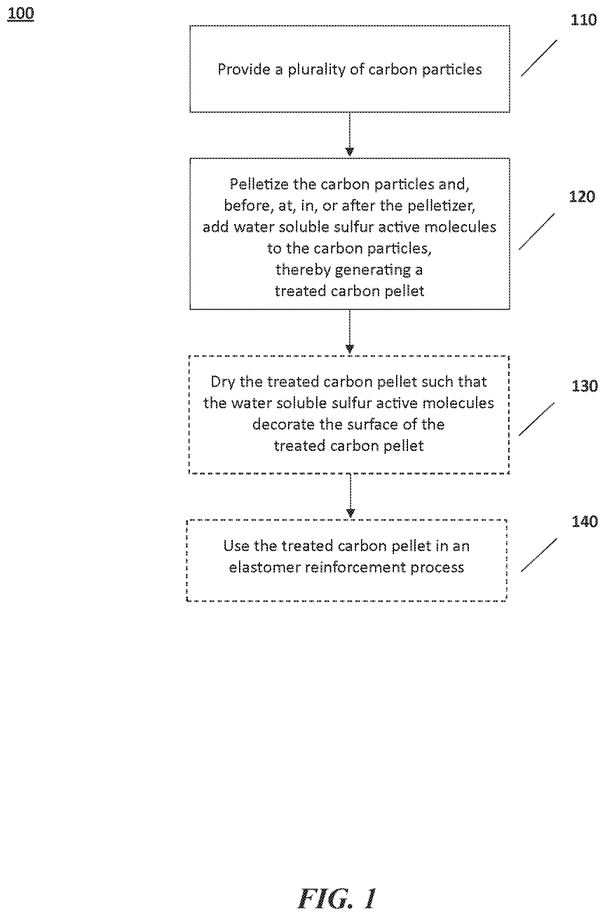

FIG. 1 shows an example method 100 according to one or more embodiments of the present disclosure. In an operation 110, method 100 may comprise providing a carbon particle. As used herein, the term “carbon particle” may refer to a particle comprising carbon. Examples of carbon particles include, but are not limited to, carbon black, coke, needle coke, graphite, large ring polycyclic aromatic hydrocarbons, activated carbon, or the like, or any combination thereof. Carbon particles may be classified into grades. The carbon particles of the present disclosure may be of any grade or no grade at all.

In some cases, prior to operation 110, the carbon particle (e.g., carbon black) may be generated in a plasma process. For example, the carbon particle may be generated using a plasma-based degradation of a hydrocarbon precursor. Non-limiting examples of plasma process generation of carbon particles can be found in at least, for example, Int. Pat. Pub. Nos. WO 2017/190015, WO 2018/195460, and WO 2023/059520, each of which is incorporated herein by reference in its entirety. In some cases, prior to operation 110, the carbon particle (e.g., carbon black) may be generated in a furnace process. The furnace process may utilize incomplete combustion of a hydrocarbon precursor to generate the carbon particle. The term “treated carbon pellet” also may be referred to herein as carbon pellet, carbon black pellet, decorated carbon particles, treated carbon particles, and/or the like. Additional steps and features of FIG. 1 are described in paragraphs below.

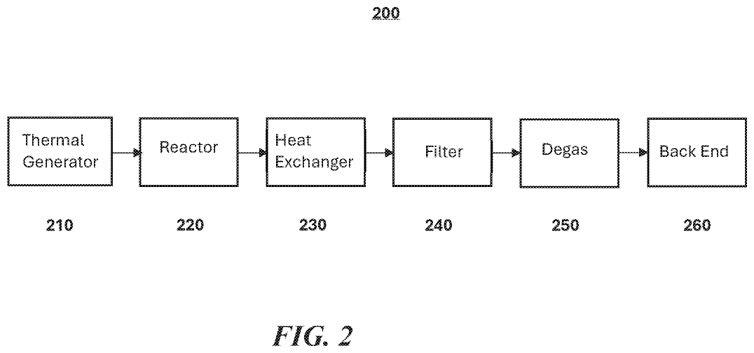

FIG. 2 shows a schematic representation of an example system 200 that can be used to provide a carbon particle (see FIG. 1, item 110) according to one or more embodiments of the present disclosure. The system 200 may include a thermal generator (e.g., a plasma generator) 210. The thermal generator 210 may heat at least a subset of one or more gases (e.g., a feedstock) at suitable reaction conditions in a reactor (or furnace) 220 to effect removal of a chemical (e.g., hydrogen) from the feedstock. The reactor 220 may contain the thermal generator (e.g., a plasma generator) 210. Heating (e.g., electrical heating, such as, for example, plasma heating) and reaction may be implemented in one chamber (e.g., “single chamber,” “single stage reactor,” or “single stage process”) or multiple chambers (e.g., “dual chamber,” “dual stage reactor,” “dual stage process,” “multiple chamber,” “multiple stage reactor,” “multiple stage process,” “multi-chamber,” “multi-stage reactor,” “multi-stage process,” or the like).

The reactor 220 may comprise one or more constant diameter regions/sections, one or more converging regions/sections, one or more diverging regions/sections, one or more additional components, or any combination thereof. Such regions/sections, or additional components, may be combined in various ways to implement the heating and reaction in accordance with the present disclosure. For example, the reactor may have a substantially constant diameter (e.g., at least about 70%, 80%, 90%, 95%, or 99% of the reactor's length may be of a constant diameter). Alternatively, or in addition, the reactor may have multiple sections, such as a first section and a second section, separated by a narrowing or a throat region (also referred to herein as a throat section or a throat). The first section may be a plasma generating section and the second section may be a carbon particle generating section. At least a subset of the one or more gases (e.g., a feedstock) may be added to the thermal generator 210.

Reaction products (e.g., solid carbonaceous material and gaseous reaction products) may be cooled after manufacture. A quench (e.g., comprising a process gas) may be used to cool the reaction products. For example, a quench comprising a majority of hydrogen gas may be used. The quench may be added (e.g., injected) in the reactor 220. A heat exchanger 230 (e.g., connected to the reactor 220) may cool an effluent stream comprising the reaction products. In the heat exchanger, gaseous reaction products may be exposed to a large surface area and thus allowed to cool while solid carbonaceous material (e.g., carbon particles) may be simultaneously transported through the process. The solid carbonaceous material may pass through a filter (e.g., a main filter) 240 (e.g., connected to the heat exchanger 230). The filter may allow, for example, more than 50% of the gaseous reaction products to pass through, capturing substantially all of the solid carbonaceous material on the filter. For example, at least about 98% by mass of the solid carbonaceous material may be captured on the filter.

The gaseous reaction products may be provided or coupled to one or more uses, recycled back into the reactor (e.g., as a process gas), or any combination thereof. The solid carbonaceous material with residual gaseous reaction products may pass through a degasser (e.g., degas chamber or degas apparatus) 250 (e.g., connected to the filter 240), where the amount of combustible gas may be reduced (e.g., to less than about 10% by volume).

The solid carbonaceous material (e.g., carbon particles) may then pass through back-end equipment 260. The back-end equipment 260 may include, for example, one or more of a pelletizer (e.g., connected to the degas apparatus 250), a binder mixing tank (e.g., connected to the pelletizer), a dryer (e.g., connected to the pelletizer), or a bagger, as non-limiting example(s) of components or unit operations. For example, the solid carbonaceous material may be pelletized in the pelletizer and dried in the dryer (e.g., mixed with water and a binder and then formed into pellets, followed by removal of the majority of the water in a dryer). The solid carbonaceous material may also pass through classifier(s), hammer mill(s), or other size reduction equipment (e.g., so as to reduce the proportion of grit in the product). As non-limiting examples of other components or unit operations, one or more of a conveying process or conveying unit, purge filter unit (e.g., which may filter solid carbonaceous material out of steam vented from the dryer), dust filter unit (e.g., which may collect dust from other equipment), other process filter, other hydrogen/tail gas removal unit, cyclone, other bulk separation (e.g., solid/gas separation) unit, off quality product blending unit, etc. (e.g., other components or unit operations described elsewhere herein) may be added or substituted in the system 200.

Components or unit operations may be added or removed as appropriate. For example, the system 200 may include at least one or more heat exchangers 230, one or more filters 240, and back-end equipment 260 comprising solids handling equipment. The solids handling equipment may include, for example, a cooled solid carbon collection screw conveyor, an air locking and purge system, a pneumatic conveying system, a mechanical conveying system (e.g., a conveyor belt auger or elevator), a classifying mill, and/or a product storage vessel. The carbon particles may be collected at a single location (e.g., all of the carbon particles may be collected at one location) or at multiple locations.

The feedstock (e.g., a Hydrocarbon feedstock comprising one or more hydrocarbons, hydrocarbon derivatives, or combination thereof) may begin to crack and decompose before being converted into solid carbonaceous material. Heat may further be provided through latent radiant heat from the wall of the reactor 220. This may occur through heating of the walls (or portions thereof) via externally provided energy or through heating of the walls (or portions thereof) from the heated gases in the reactor 220. For example, hydrogen and carbonaceous material (e.g., carbon particles) may be produced in a process comprising adding a hydrocarbon feedstock (e.g., natural gas, renewable natural gas, toluene, carbon black oil, or any other hydrocarbon, hydrocarbon derivative, and/or hydrocarbon mixture feedstock as described above) to a plasma reactor 220 at or above atmospheric pressures. The hydrocarbon feedstock may be added through direct injection (e.g., direct injection of the feedstock) into the plasma generated by the thermal generator (e.g., plasma generator) 210. The energy from the thermal generator 210 may remove hydrogen from the hydrocarbon feedstock. The process may additionally include the use of one or more heat exchangers 230, filters 240, degas chambers 250, and/or solids handling equipment and other back-end equipment 260 as described above.

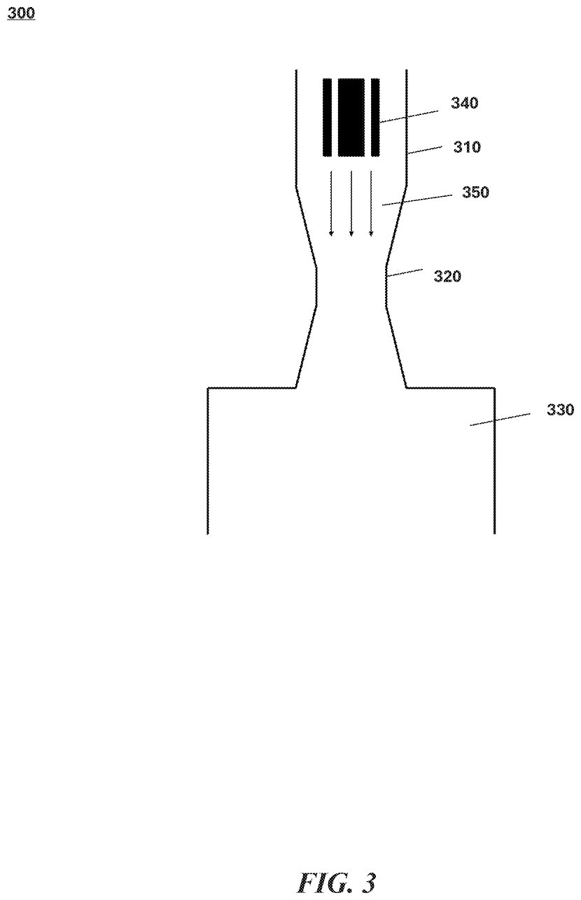

FIG. 3 shows an example of a plasma reactor 300 (see FIG. 2, item 220) that can be used to provide a carbon particle (see FIG. 1, item 110), according to one or more embodiments of the present disclosure. The plasma reactor 300 may be configured to execute the methods as described elsewhere herein. For example, the plasma reactor 300 may be configured to generate carbon particles as described elsewhere herein. The plasma reactor 300 may comprise an upstream section (e.g., torch region) 310, a throat section 320, and/or a downstream section (e.g., reactor region) 330. The upstream section 310 may comprise one or more plasma torches 340. The one or more plasma torches 340 may comprise at least about 1, 2, 3, 4, 5, 6, 7, 8, 9, 10, or more plasma torches. The one or more plasma torches 340 may be configured to provide a plasma (not shown) to the upstream section (e.g., torch region) 310. For example, the one or more plasma torches 340 may be configured to transform a gas (e.g., a transfer gas) into a plasma with aid of electrical energy. The plasma may be configured for use as a reactant in a carbon particle generating method. For example, the plasma may be used to provide heat to a carbon particle generating method. The plasma torch 340 may comprise an electrically conductive material. Examples of electrically conductive materials include, but are not limited to, carbon (e.g., graphite, glassy carbon, etc.), metals (e.g., iron, tungsten, gold, etc.), alloys (e.g., steel, etc.), polymers (e.g., conductive polymers), or the like, or any combination thereof. The plasma torch 340 may comprise a plurality of segments. For example, the plasma torch 340 may comprise a plurality of electrode portions (e.g., an anode, a cathode, a ground, or a combination thereof).

A gas (e.g., a transfer gas) may flow through the plasma reactor 300 in a bulk flow direction 350. For example, the direction of gas flow 350 can be from the upstream section (e.g., torch region) 310 through the throat section 320 into the downstream section (e.g., reactor region) 330. A transfer gas may be introduced to the plasma reactor 300 upstream of the upstream section (e.g., torch region) 310. For example, the transfer gas may be introduced via a pipe disposed upstream of the plasma torch 340. A transfer gas may be introduced to the plasma reactor 300 upstream of the throat section 320, in the throat section 320, downstream of the throat section 320, in the upstream section (e.g., reactor region) 310, or any combination thereof. Introducing transfer gas downstream of the plasma torch 340 may impact the temperature, flow rate, reaction rate, concentration, dilution, etc. of the plasma reactor 300.

The plasma reactor 300 may comprise one or more material injectors (not shown) that may be used to inject a feedstock (e.g., a hydrocarbon feedstock as described above) or other material. The injectors may be located upstream of the upstream section (e.g., torch region) 310, in the upstream section (e.g., torch region) 310, in the throat section 320, in the downstream section (e.g., reactor region) 330, or any combination thereof. Each section of the plasma reactor 300 may comprise one or more injectors. The one or more injectors may be distributed radially around or within the plasma reactor 300 or in any other configuration. The one or more injectors in a set or plurality of injectors may be configured to inject a same type of material. For example, each injector in a set or plurality of injectors may be configured to inject a hydrocarbon feedstock. For example, each injector in a set or plurality of injectors may be configured to inject a majority of a hydrocarbon feedstock downstream of an obstacle modulating a reacting flow, as described in Int. Pat. Pub. No. WO 2024/086782, incorporated by reference herein in its entirety.

The one or more injectors may be configured to inject a plurality of types of feedstock or other material. For example, the injectors may be configured to inject one or more gases, one or more liquids (e.g., carbon black oil with or without another compound or combination of compounds), both a gas and a liquid (e.g., both natural gas and an aromatic compound), or mixtures thereof, separately or at the same time. In some cases, separate gas and liquid injectors may be used to inject the feedstock. In some cases, the gaseous feedstock (e.g., natural gas, renewable natural gas, or any other gas phase hydrocarbon feedstock as described above) can be used to atomize a liquid or semi-liquid feedstock (e.g., feedstock that is heated to achieve a predetermined flow rate through the system). In some cases, the injectors may be configured to inject liquid only (e.g., toluene, carbon black oil, or any other liquid phase hydrocarbon feedstock as described above).

The plasma reactor 300 may comprise no or substantially no restriction or obstacle between upstream section 310 and downstream section 330 in or near the throat section 320. Such a reactor may generate larger carbon particles (e.g., not nanoparticles and/or not carbon black) or solids comprising a large primary particle size. This can result in equipment fouling. Fouling material may be an unwanted buildup of solids on containment walls (e.g., internal walls of the reactor 300). Fouling may generate run-away propagation and premature shutdown of equipment. Buildup of solids on the containment walls (e.g., reactor fouling) may be reduced through control of time of flight of reacting flows using the systems and methods (hereinafter collectively referred to as the “Flow Straightener”) of the aforementioned Int. Pat. Pub. No. WO 2024/086782, incorporated by reference above. The methods and additives of the present disclosure can provide for improvements to the elastomer reinforcement properties of carbon particles produced in a system or by a method comprising a Flow Straightener.

Returning to FIG. 1, in some cases, prior to operation 110, the carbon particle can be degassed (see FIG. 2, item 250). The degassing may comprise an at least partial removal of one or more gases from the carbon particle. The one or more gases may be associated with the carbon particle from the synthesis of the carbon particle (e.g., gases from the synthesis atmosphere, byproduct gases from the synthesis, etc.), from the processing of the carbon particle (e.g., carrier gas added during the movement of the carbon particle through the generation system, etc.), a quench gas, an additive gas, or the like, or any combination thereof. Examples of carrier gases include, but are not limited to, carbon monoxide, hydrogen, argon, krypton, other noble gases, and nitrogen.

The degassing may remove reactive gases, non-reactive gases, or both reactive and non-reactive gases from the carbon particle. In some cases, the degassing may remove reactive gases from the carbon particle. For example, for a carbon particle generated with hydrogen or in a hydrogen environment, the degassing may remove at least a part of the hydrogen from pores of the carbon particle, thereby improving the safety of handling the carbon particle. The degassing to remove hydrogen from the pores of a carbon particle may be considered complete when the hydrogen level is reduced to, for example, less than or equal to about 20, 15, 10, 5, or less percent by volume. The removal of reactive gases from a carbon particle by degassing the carbon particle can reduce variability in reactivity of different carbon particles. For example, the removal of the reactive gases can provide carbon particles with a same or substantially same reactivity which can, in turn, homogenize downstream reaction conditions. In some cases, the degassing may remove non-reactive gases from the carbon particle. For example, the degassing may remove a process gas (e.g., argon, carbon dioxide, nitrogen, etc.) from the carbon particle.

Examples of morphologies of carbon particles include, but are not limited to, disks, bowls, cones, aggregated disks, few layer graphene (FLG), ellipsoids, aggregated ellipsoids, spheres, aggregated spheres, or the like, or any combination thereof. A plurality of carbon particles may comprise carbon particles of a plurality of morphologies.

As mentioned above, in one or more embodiments of the present disclosure, a water soluble sulfur active species decorates the carbon black particle. In one or more embodiments, the water soluble sulfur active species may be used in combination with elemental sulfur supplied in colloidal form. When carbon black particles decorated with the water soluble sulfur active species are compounded with an elastomer, the water soluble sulfur active species may enhance the polymer-filler interaction through chelation of the activating agent (e.g., zinc ions (Zn2+)) and potentially release free radicals. This further increases the cross-link density of sulfur chains at or in the vicinity of the carbon black surface, thereby improving performance of the overall elastomeric composition (elastomer compound) and/or rubber article.

In one or more embodiments, the water soluble sulfur active species can be selected, individually or in combination, from the following group of water soluble sulfur active molecules.

Dithiocarbamates. Some examples of advantageous water soluble sulfur active molecules of the present disclosure are dithiocarbamates (DTCs). Acceptable dithiocarbamates include at least sodium diethyldithiocarbamate, sodium dimethyldithiocarbamate, and sodium bis(2-hydroxyethyl)dithiocarbamate. The solubility of these dithiocarbamates is greater than 150 grams per liter (g/L) in water at 25° C. Another example of an acceptable dithiocarbamate is sodium pyrrolidine dithiocarbamate, which has a lower solubility in water at 50 g/L but is also a water soluble sulfur active species within the scope of this disclosure. Another example of an acceptable dithiocarbamate is sodium dibenzyl dithiocarbamate, which is water soluble (>50 g/L) yet is formed by reacting essentially insoluble dibenzyl amine in a basic aqueous sodium hydroxide solution with carbon disulfide (CS₂). In this way, many insoluble primary and secondary amines can be made into soluble dithiocarbamates through reaction with carbon disulfide.

For example, dithiocarbamates can be synthesized from the secondary amines reacting with carbon disulfide (CS₂) in water in the presence of an excess of sodium hydroxide (NaOH). The nucleophilic action of the amine on the electropositive carbon center drives the reaction. After the product dithiocarbamic acid is formed, a fast reaction occurs with the sodium hydroxide to form the sodium salt, which has the dual benefit of being water soluble as well as being trapped at the carbon surface. (See, e.g., reaction of dibenzyl amine referenced above.).

A non-limiting list of potential amines that can be reacted with carbon disulfide (CS₂) to form dithiocarbamates include: N-methyl-1-naphthalen-1-yl-methanamine, 1-naphthylamine, N-phenyl-1-naphtylamine, 4-aminoantipyrine, poly(ethylene glycol) diamine, diisopropyl amine, diethyl amine, morpholine, piperidine, dicyclohexylamine, piperazine, N,N′-dimethylenetriamine, diethylenetriamine, 3-methoxypropyl amine, 1-(2-hydroxyethylpiperazine), benzylamine, 4-aminophenyl disulfide, dibenzylamine, 2-imidazolidinethione, 3 amino-1H-1,2,4-triazole, 3-mercapto-1,2,4-triazole, 4-amino-1,2,4-triazole, N,N′-diethylthiourea, 1,3-diphenylguanidine, p-phenylenediamine, cystamine, aminoguanidine, 4-aminophenyl sulfone, pyrrole, ethylene diamine, N, N′-dimethyl thiourea, melamine, phthalimide, etc. It is recognized that amines other than those identified herein may be reacted with carbon disulfide to produce a diothiocarbamate to be used as the water soluble sulfur active species in accordance with embodiments.

The general chemical structure for a dithiocarbamate is shown below:

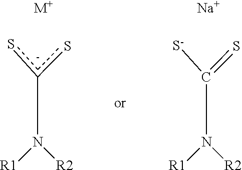

R1 and R2 can be hydrogen or any number of alkyl, aryl, benzyl, alkyl with heteroatom substituents, etc. For instance, in the example sodium pyrrolidine dithiocarbamate, the two R groups form a cyclic ring which can be substituted with one or more of a multitude of groups such as hydroxyl or phenyl groups in order to change the hydrophilicity or chemical function of the dithiocarbamate. Examples of other nitrogen heterocycles include pyridine, pyrrole, imidazole, pyrimidine, quinoline, and purine. Stated another way, R1 and R2 can be or include any of a number of categories, including hydrogen, hydrocarbon (alkyl, alkenyl, aryl, combinations thereof, etc.), and hydrocarbons possessing heteroatom functionality. For the functional hydrocarbons, the heteroatoms may include oxygen, nitrogen, sulfur, phosphorus, silicon, etc. The oxygen functionality may include hydroxyl, carbonyl, aldehyde, ketone, carboxyl, ester, ether, peroxide, etc. The nitrogen functionality may include amine, amide, nitrile, nitro, nitroso, imine, etc. The sulfur functionality may include thiol, sulfide, sulfoxide, sulfonyl, sulfite, sulfate, etc.

Other water soluble dithiocarbamates of the present disclosure may include, for non-limiting example, sodium dimethyldithiocarbamate, sodium diethyldithiocarbamate, sodium dibutyldithiocarbamate, sodium dipropyldithiocarbamate, sodium ethylenebisdithiocarbamate (Nabam), and ammonium ethylenebisdithiocarbamate (Amobam), and/or the like, or any combination thereof.

Possible positive counterions to the negatively charged dithiocarbamate include sodium, potassium, ammonium, lithium, rubidium, cesium, magnesium, calcium, strontium, and zinc, as well as any other potential transition metal salts such as (for example) iron, copper, and nickel. Ammonium and alkyl derivatives thereof, such as methylammonium or ethylammonium, dimethylammonium, imidazolium, pyridinium, etc. can also be envisaged as the positive counterion. More exotic counterions such as trimethyl sulfonium, dimethyl sulfonium, tetramethylphosphonium, etc. can also be seen as suitable counterions.

The cations in these dithiocarbamate (and also xanthate and other water soluble sulfur active species discussed below) chemical compounds are not limited to monovalent lithium, sodium, potassium, and ammonium type of species. The cation can be monovalent, divalent, trivalent, tetravalent, pentavalent, and even hexavalent. The positive counterion can be from the alkali metals, alkaline earth, transition metal, lanthanides, actinides, or the main group elements.

It is noted, however, that typically, divalent cations cause the sulfur active species to become insoluble in water due to the lack of hydration in the compound as the exterior facing portion of the molecule possesses only organic groups. For example, dimethyldithiocarbamate sodium salt is completely miscible with water, and solutions up to 40 weight percent (wt. %) can be prepared. In contrast, the corresponding zinc salt is completely water insoluble. Thus, one way to make the divalent compound water soluble is to replace a pure alkyl group with a heteroatom substituted alkyl group such as methyl with methoxy.

Thiocarbamates. In one or more embodiments, thiocarbamates may be used to activate the surface of the carbon black as the water soluble sulfur active species of the present disclosure. An example chemical structure for thiocarbamates is shown below:

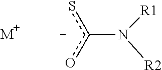

As can be seen in the chemical structure of thiocarbamate, one of the sulfur groups in the previous depiction of dithiocarbamate has been replaced by an oxygen atom. All of the same organic species can be envisaged at R1 and R2 as well as positive counterions as described for the dithiocarbamates above.

Xanthates. Examples of water soluble xanthates that can be used in embodiments as the water soluble sulfur active species of the present disclosure include sodium ethyl xanthate, sodium isopropyl xanthate, sodium isobutyl xanthate (SIBX), sodium methyl xanthate (SMX), sodium pentyl xanthate (SPX), sodium cyclohexyl xanthate (SCX), ammonium xanthate, and calcium xanthate.

Xanthates can be synthesized from alcohols reacted with carbon disulfide (CS₂) in water, typically in the presence of a base. Alcohols that can be reacted with carbon disulfide to form the corresponding xanthate include: lignosulfonate, basified tannic acid, cardanol, farnesol, geraniol, 1,1,2,2-tetraphenyl-1,2-ethanediol, ethanol, phenol, phenylethanol, butanol, etc.

It is also envisioned that a mixture of alcohols and amines can be incorporated into the same molecule to make a mixture of dithiocarbamates and xanthates in the same species. For example, starting materials such as product of Mannich reaction with lignosulfonate, 2-dimethylaminoethanol, 4-amino-1-butanol, poly(vinyl alcohol-co-vinyl amine), hydroxyl-functionalized linear poly(amidoamine), poly(glycidyl methacrylate) reacted with ethanolamine, poly(beta-hydroxyl amines (reaction between diepoxides and amines) can be reacted with carbon disulfide typically in the presence of a base to form chemicals that possess both a dithiocarbamate and a xanthate in the same molecular structure.

The general chemical structure for xanthates is shown below:

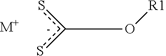

The R1 group and the counterion should be considered to be the same or similar to the candidates listed for dithiocarbamates/thiocarbamates above.

Thioureas. Thioureas or thiocarbamides can be used in embodiments as the water soluble sulfur active species of the present disclosure. Common thioureas or thiocarbamides are N, N′-dimethylthiourea, ethylene thiourea (ETU, 2-imidazolidinethione), diethylthiourea (DETU), tetramethylthiourea (TMTU), and thiourea. The general chemical structure for thioureas is shown below (where R1-R4 are selected from the candidates listed for dithiocarbamates/thiocarbamates above):

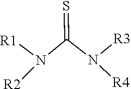

Thiurams. Thiurams can be used in embodiments as water soluble sulfur active species of the present disclosure. The general chemical structure for thiurams is shown below:

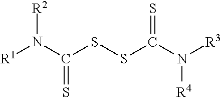

Most thiurams are insoluble in water, but replacing at least a portion R1-R4 groups with at least one polar group, such as an amine, alcohol, carboxylic acid, or the like, would make this class of compounds water soluble and therefore, in embodiments, capable of use as the water soluble sulfur active species of the present disclosure. The remaining R1-R4 groups may be selected from the candidates listed for dithiocarbamates/thiocarbamates above.

Other species. Other water soluble sulfur active species can be utilized as the water soluble sulfur active species of the present disclosure. Examples include functionalized lignosulfonate (typically used as a binder for pelletization), sodium mercaptobenzothiazole, 5-amino-2-mercaptobenzimidazole, sulfenamide, mercaptobenzothiazole sulfenamide, and related compounds. The only requirements to be in the broader category of water soluble sulfur active species are that the compound must be water soluble (e.g., have a water solubility of greater than or equal to about 20 grams per liter (g/L), 30 g/L, 40 g/L, 50 g/L, or more at 25° C.) and must possess at least one carbon atom, at least one hydrogen atom, and at least one sulfur atom. Additionally, the compound may activate the carbon surface in the form of increasing M300 or M300/M100 compared to a baseline (e.g., reference) carbon black that does not have the water soluble sulfur active species finely decorated at the surface (as described further below).

In embodiments, additional compounds may be added with or in addition to the water soluble sulfur active species, i.e., carbon particles may be decorated with additional compounds before, at, in, or after the pelletizer, as described in the non-limiting examples below.

Cure Retarders. If the elastomer cure is too fast due to the addition of the water soluble sulfur active species and the compound becomes scorchy, cure retarders can be added to reduce the speed of the cure. Other retarding agents can be or include Pilgard PVI (pre-vulcanization inhibitor), NDPA phthalic anhydride, 4, 5-methylbenzotriazole, sulfonamide, N-cyclohexylthiophthalimide, salicylic acid, etc.

Amines, for example 1,3-diphenylguanidine (DPG), can be added before, in, or after pelletization as well. The basic form of DPG, shown below, does not dissolve in water; however, in acidic solutions, the salt forms, and, depending upon the counterion, this salt is normally soluble in water.

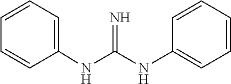 [SMILES: N=C(Nc1ccccc1)Nc1ccccc1]

For example, in hydrochloric acid solution, the ammonium chloride salt will form and dissolve in the water. The DPG additive can work in combination with dithiocarbamates at the surface of the carbon black, upon mixing with (e.g., compounding into) an elastomer, to accelerate curing or to improve other desired properties. Another candidate is mercaptobenzothiazole sodium salt, which also may be added to the surface of the carbon black. These types of molecules can be added alone or in addition to the water soluble sulfur active species in order to increase the activity of the water soluble sulfur active species. These can be added, for example, via 1 pen or 2 pen pelletization. In the case of DPG and similar molecules, the 2 pen pelletization may be necessary due to the incompatibility of dithiocarbamates with acidic solutions, i.e., the dithiocarbamates decompose to carbon disulfide (CS₂) and the corresponding amine.

The water soluble sulfur active molecules of the present disclosure may have a given water solubility. In some examples, the water solubility may be greater than or equal to 20 to 50 grams (g) of the water soluble sulfur active molecules (solute) per liter (L) of water (solvent) at 25° C. In some examples, the water solubility may be greater than 30 or 40 g/L at 25° C. The water solubility may be, for example, greater than or equal to about 20, 25, 30, 40, 50, 60, 80, 100, 150, 200, 300, 400, 500, 600, 750, 1000, or more g/L, up to a maximum of full miscibility with water at 25° C. Alternatively, or in addition, the water solubility may be less than or equal to full miscibility, for example, less than or equal to about 1000, 750, 600, 500, 400, 300, 200, 150, 100, 80, 60, 50, 40, 30, 25, 20 or less g/L. The water solubility may be within a range defined by any two of the preceding values. For example, the water solubility of the water soluble sulfur active molecules of the present disclosure may be in a range of about 20 g/L to full miscibility, from about 25 g/L to about 600 g/L, from about 30 g/L to about 300 g/L, etc.

Without being bound to any particular theory or hypothesis, it is believed that the water soluble sulfur active molecules of the present disclosure have particularly attractive characteristics for plasma carbon black, including as an accelerator trapped at the surface of the carbon black particle in mixing with rubber or other elastomers. For example, dithiocarbamates are known free radical scavengers. Due to the hydrophilic nature of the dithiocarbamate salts, these molecules do not have a high compatibility with the rubber melt and will stay at the surface of the carbon black particle. During mixing, elastomer (e.g., rubber) chains as well as carbon black aggregates will homolytically break and react to form free radical adducts with any available reactive centers such as free radical traps. The presence of the dithiocarbamate salts could create an increased interaction, thus creating an interphase between the carbon black surface and the elastomer where a higher crosslink density of rubber could be created. This would result in what is known as greater “polymer-filler” interaction, which would subsequently result in higher M300, M300/M100 ratio, and resistance to DIN Abrasion, all of which are signs of greater reinforcement with the surface treated carbon black particles. The chain of events as stated does not depend on any (many) covalent bonds between the carbon black surface and the dithiocarbamate salts.

The above mechanism is testable by adding zinc oxide (ZnO) to the rubber mix in the non-productive step or by taking the non-productive mix to low temperature (e.g., drop temperature <130° C.). Indeed, when a rubber formulation that utilizes ZnO in the non-productive step at low temperature, such as in ASTM D3191, is attempted, there might be very little improvement over the baseline carbon black. If this were the case, it would make the discovery of the dithiocarbamate salts and other such water soluble sulfur active molecules difficult, as the quick method of evaluating carbon black in rubber is to utilize ASTM D3191 to mix carbon black with emulsion styrene-butadiene rubber (ESBR) and measure the output parameters such as M300, M100, scorch, cure time, DIN Abrasion, etc. The hypothesized reason that the dithiocarbamate salt is not effective when added with ZnO at low temperature is that the dithiocarbamate is not reaching temperatures at which it becomes reactive and very few free radicals are being generated at the lower temperatures. In natural rubber mixes at higher drop temperatures above 150° C. or 160° C., substantial chain scission occurs through homolytic breakage of bonds. This will make the water soluble sulfur active species even more reactive and possibly produce results wherein even greater reactivity with rubber, also known as increased polymer-filler interaction, occurs.

Another interesting caveat is that if one adds zinc dithiocarbamate salts to the surface of the carbon black, little to no improvement is observed compared to adding the sodium salt of the dithiocarbamate to the carbon black prior to mixing and then adding the ZnO in a second step, known in the rubber industry as the “productive” step. It is hypothesized that the water soluble sulfur active species needs to not only possess strong free radical interactions, but also be able to complex zinc ions and further facilitate the vulcanization reaction between sulfur, accelerator, carbon black, and elastomer. The triple functionality of free radical reactivity, chelating ligand or strong ligand effect, and/or being hydrophilic and not lipophilic, could be the reason(s) that the water soluble sulfur active species of the present disclosure are so effective at activating the carbon black surface to enable the reinforcement to rubber compounds.

The above mechanism also may be testable by reacting a liquid hydrocarbon feedstock rich in amine and/or alcohol functionalized polycyclic aromatic hydrocarbons (PAHs), for example, carbon black oil (CBO) or another heavy molecular-weight hydrocarbon mixture (e.g., average of at least 150 g/mol), with carbon disulfide (CS₂) in a basic aqueous solution, then pelletizing the carbon black with either an augmented direct spray of the PAH or an emulsion of the liquid hydrocarbon feedstock (e.g., oil) functionalized with CS₂, to form dithiocarbamates and/or xanthates for decoration of the carbon particle surface.

Returning to FIG. 1, in another operation 120, the example method 100 of the present disclosure may comprise pelletizing the carbon particles and, before, at, in, or after the pelletizer (see, e.g., FIG. 2 after degas 250), adding water soluble sulfur active molecules (as an additive or in an additive mixture), thereby generating a treated carbon pellet.

An additive mixture to the pelletizing solution may comprise one or more water soluble sulfur active species. The additive mixture further may comprise one or more of a filler (e.g., silica, other carbon particles, etc.), an oil (e.g., an organic oil, a silicon oil, etc.), a metal oxide activating agent (e.g., zinc oxide, titanium oxide, etc.), a peroxide or a reaction product therefrom (e.g., hydrogen peroxide, benzoyl peroxide), a sulfur containing compound (e.g., sulfur, a benzenesulfenamide, etc.), a vulcanization accelerator (e.g., a thiuram, dithiocarbamate, benzenesulfenamide, etc.) an organic acid acting as co-activating agent (e.g., stearic acid, etc.), etc., or the like, and a binder (lignosulfonate, Tween® 80, PEG, etc.) or any combination thereof. Other examples of the components of an additive mixture may be found at chapter 7, page 337 of “The Science and Technology of Rubber” (Mark, Erman, and Roland, Fourth Edition, Academic Press, 2013), the disclosure of which is incorporated by reference herein in its entirety.

In an example of operation 120, water may be used to pelletize the carbon particles (e.g., carbon black). Additive(s) or an additive package that is or comprises water soluble sulfur active molecules may be mixed into water and dissolved or dispersed (e.g., if colloidal sulfur). The water, and the additive(s) or additive package dissolved or dispersed therein, then may be sprayed onto the carbon particles in a pin agglomerator. The pin agglomerator may be utilized to pelletize the carbon particles, which may change a pour density of the carbon particles (e.g., from about 100 kg/m³ to about 300 or 400 kg/m³), and generate the treated carbon pellets. The wet treated carbon pellets may be dried 130 and the water removed in substantial part after the additive(s) or additive package has been added and is finely distributed across the carbon particle surface. The release of the water can provide enhanced local concentrations of moisture in an elastomer/treated carbon pellet mixture and can result in improved performance of the treated carbon pellet (and thereby the carbon particles) in an elastomer reinforcement process 140.

In operation 120, a method of spraying the fluffy carbon black with dissolved or emulsified water soluble sulfur active molecules (also referred to as “species” herein) during pelletization is advantageous because, after drying, the carbon black will be decorated with nano-sized domains of the sulfur active species. This is a very different methodology than physically mixing the sulfur active species with the carbon black in a purely mechanical method such as adding the carbon black to the sulfur active species in the non-productive step of the rubber mixing process.

Another methodology to prepare the carbon black surface in operation 120 is to spray the water soluble sulfur active molecules onto the carbon black surface either neat or in an organic solvent such as ether, ethanol, tetrahydrofuran (THF), acetone, ethylene glycol, or similar organic solvents. These can optionally be heated in order to increase the solubility of the species that is being added to the carbon black surface. The water soluble sulfur active species also can be applied to the surface via non-water solvents or via an oil-water emulsion, for example.

In operation 120, the additive mixture may be added to the carbon particle by, for example, addition of a binder comprising the additive mixture. For example, the additive mixture may be suspended or dissolved in water and/or be in the form of an aqueous solution, and the water, additive mixture, and/or aqueous solution can be added to (e.g., contacted with) the carbon particle. The additive mixture can be added to the carbon particle at a feed bin of a pelletizer, as a neat spray, as a diluted spray (e.g., diluted with a solvent), or the like, or any combination thereof.

In embodiments, operation 120 may comprise adding a pelletizer solution to the carbon particle. The pelletizer solution may be configured to bind the carbon particle to one or more other carbon particles, thereby forming a carbon pellet comprising the carbon particle. The additive mixture may comprise the pelletizer solution. For example, the pelletizer solution may be at least a portion of the additive mixture. In embodiments, the pelletizer solution may be added to the carbon particle before, with, or after the additive mixture (anywhere after the degas and before the drying step). The pelletizer solution may comprise, by way of non-limiting example, water, water soluble binders such as lignosulfonate, sugar, molasses, polysorbate polymers (e.g., Tween® 80, Tween® 20, etc.), polyethylene glycol, or the like, or any combination thereof.

In embodiments, levels of sulfur, oxygen, nitrogen, and hydrogen may exist on (or load) the surface of treated carbon particles (or pellets). Such levels may comprise native surface group concentrations as well as molecules added by way of the water soluble sulfur active species decoration or other additive deposits.

In embodiments, the additive mixture may comprise one or more sulfur containing compounds. Examples of sulfur containing compounds include, but are not limited to, organometallic sulfur compounds (e.g., a compound comprising sulfur or a sulfur containing species bound to one or more metal ions), metallic sulfur (e.g., a compound comprising a metal ion bound to a sulfur or sulfur containing ion), polysulfides, sulfides, free sulfur, or the like, or any combination thereof. The sulfur containing compounds may be present at a ratio of at least about 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 11, 12, 13, 14, 15, 16, 17, 18, 19, 20, or more percent by mass of the total mass of the carbon pellet sample after drying. The sulfur containing compounds may be present at a ratio of at most about 20, 19, 18, 17, 16, 15, 14, 13, 12, 11, 10, 9, 8, 7, 6, 5, 4.5, 4, 3.5, 3, 2.5, 2, 1.5, 1, 0.9, 0.8, 0.7, 0.6, 0.5, 0.4, 0.3, 0.2, 0.1, 0.05, 0.01, or less percent by mass of the total mass of the carbon pellet sample after drying. The sulfur containing compounds may be present in a ratio within a range defined by any two of the preceding values. For example, the sulfur containing compounds may be present at a ratio in a range of about 0.05 to about 0.8 percent by mass, about 0.1 to about 1 percent by mass, about 0.2 to about 4 percent by mass, etc., or at sulfur levels on the decorated carbon black particles (treated carbon pellets) of less than or equal to 1% by mass. In embodiments, a sulfur level on the surface of treated (e.g., decorated) carbon particles (or pellets) is less than about 2, 1.5, 1, 0.9, 0.8, 0.7, 0.6, 0.5, 0.4, 0.3, 0.2, or 0.1% by mass. The mass percentage may be a total mass percentage (e.g., mass percentage of a total composition comprising the carbon particles). The mass percentage may be with respect to the carbon particles (e.g., the mass percentage of the water soluble sulfur active molecules and the carbon particles). For example, an additive mixture may comprise 0.3% dithiocarbamate (DTC) by mass and 0.2% colloidal sulfur by mass, with the remaining mass (e.g., carbon black) at 99.5%, or if there is 0.3% binder, with the remaining mass (e.g., carbon black) at 99.2%. Or there may be a total of 98% or more carbon black. The amount of sulfur containing compound may be similar or substantially similar to the amount of DTC contained within the additive mixture. The sulfur containing compound can be in the form of one or more molecules, nanoparticles (e.g., particles with a size less than or equal to about 2 micrometer volume equivalent sphere), particles (e.g., particles with a size up to about 10 micrometers, 50 micrometers, 100 micrometers, 150 micrometers, or more), or the like, or any combination thereof. After drying, the DTC or other water soluble sulfur active species may exist as the hydrate.

In embodiments, an oxygen level on the surface of treated (e.g., decorated) carbon particles (or pellets) is less than about 1, 0.9, 0.8, 0.7, 0.6, 0.5, 0.4, 0.3, 0.2, or 0.1% by mass. In embodiments, a nitrogen level on the surface of treated carbon particles (or pellets) is less than about 0.2, 0.15, 0.12, 0.11, 0.10, 0.09, 0.08, 0.07, 0.06, or 0.05% by mass. In embodiments, a hydrogen level on the surface of treated carbon particles (or pellets) is less than about 0.5, 0.4, 0.35, 0.3, 0.25, 0.2, 0.15, or 0.1% by mass.

With continued reference to FIG. 1 operation 120, the method 100 may comprise pelletizing the treated carbon particle to generate a carbon pellet. For example, the pelletizing may be a process by which a plurality of carbon particles (e.g., in the form of a fluffy carbon powder) before, during, and/or after treatment, may be transformed or agglomerated into a larger mass particle or carbon pellet (also “treated carbon pellet” herein). The pelletizing may comprise use of one or more of heat, pressure, vacuum, or the like, or any combination thereof. The pelletizing may be performed at a temperature of at least about 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, or more degrees Celsius (° C.). The pelletizing may be performed at a temperature of at most about 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, 25, 20, or less ° C. The pelletizing may occur at a temperature in a range defined by any two of the preceding values. For example, the pelletizing may occur at a temperature in a range from about 40° C. to about 300° C.

The pelletizing of operation 120 may comprise use of a pelletizer. The pelletizer may comprise a pin agglomerator. The pin agglomerator may have one or more (e.g., two) pens or injectors of liquid. Using the one or more pens or injectors of liquid, a superabsorbent polymer can be synthesized on the surface of the carbon particle in the pin agglomerator. For example, in a first pen, a monomer (e.g., sodium acrylate) can be present and, in a second pen, an initiator (e.g., ammonium persulfate) and a crosslinker (e.g., N,N′-methylenebisacrylamide) can be injected. In this example, the reaction to form the superabsorbent polymer (e.g., superabsorbent crosslinked polyacrylamide) can occur at the surface of the carbon particle. The preparation of the superabsorbent polymer at the surface of the carbon particle or plurality of carbon particles can provide the carbon pellet with a moisture content of at least about 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, or more percent.

Subsequent to pelletization, the treated carbon pellet may be dried. In an optional operation 130, the method 100 may comprise drying the treated carbon pellet to a moisture content of at least about 0.2% and at most about 5%. The drying operation 130 may comprise use of, for example, a rotary kiln, a vibratory fluidized bed dryer, a fluidized bed dryer, a tray dryer, or the like, or any combination thereof. The drying may comprise use of an oven. The drying (e.g., oven drying, fluidized bed drying, etc.) may occur at a temperature of at least about 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, or more degrees Celsius (° C.). The drying may occur at a temperature of at most about 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, or less ° C. The drying may occur at a temperature in a range as defined by any two of the preceding values. For example, the drying may occur at a temperature in a range of about 50° C. to about 80° C. For another example, the drying may occur at a temperature in a range of about 100° C. to about 250° C.

The drying 130 of the treated carbon pellet may improve the performance of the generated treated carbon pellet 120 in an elastomer reinforcement process 140. For example, in embodiments, the drying of the treated carbon pellet (e.g., to a moisture content of less than or equal to about 5%) may contribute to improved performance of the treated carbon pellet in an elastomer reinforcement process. In other cases, the drying 130 of the treated carbon pellet may have no effect on or may decrease the performance of the generated carbon pellet 120 in an elastomer reinforcement process 140. For example, the overdrying of the carbon pellet (e.g., to a moisture content of less than about 0.2%) may remove almost all of the water from the pellet, which can decrease the performance of the pellet in an elastomer reinforcement process.

The treated carbon pellet may have a bed temperature (e.g., a temperature of the carbon pellet directly after pelletization 120) of at least about 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, or more degrees Celsius (° C.). The treated carbon pellet may have a bed temperature of at most about 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, or less ° C. The bed temperature may be a temperature in a range as defined by any two of the preceding values. For example, the bed temperature can be in a range from about 50° C. to about 120° C. A bed temperature can be measured through the immediate piling of the treated carbon pellets after pelletization 120 and an insertion of a thermocouple into the pile. A vibratory fluidized bed (VFB) dryer can operate at a bed temperature in a range of about 45° C. to about 90° C., with an incoming hot air stream at a temperature in a range of about 200° C. to about 500° C. The hot air stream can be moved through the vibrating bed via small holes disposed throughout the bed, thereby increasing the amount of water that can be removed from the treated carbon pellets while maintaining a lower overall temperature (e.g., less than about 120° C.).

In embodiments, after pelletization/treatment operation 120 and optional drying operation 130, the method 100 may comprise using the treated carbon pellet in an optional elastomer reinforcement process 140. For example, the treated carbon pellet may be a reagent in the preparation of a reinforced elastomer. In this example, the material properties of the elastomer can be changed by the presence of the treated carbon pellet and the reinforcement process. For example, the elastomer reinforcement process may comprise rubber vulcanization. For example, the treated carbon pellet may be compounded into a rubber to generate a vulcanized rubber. Many types of elastomers are amenable to reinforcement using the methods and additives of the present disclosure, as described further below.

In operation 140 of example method 100, the treated carbon pellet of the present disclosure may be mixed with an elastomer (e.g., as a portion of an elastomer reinforcement process or reaction) to create an elastomer compound (e.g., for use in a rubber article). The mixing of the treated carbon pellet with the elastomer may result in an increased temperature of the elastomer/pellet mixture. For example, use of a mechanical mixer can generate heat during mixing due to, for example, the mechanical forces applied to the elastomer, friction of mixing, etc. The mixing of the treated carbon pellet with the elastomer can occur at a temperature of at least about 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, or more degrees Celsius (° C.). The mixing of the treated carbon pellet with the elastomer can occur at a temperature of at most about 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, 25, 20, or less ° C. The mixing of the treated carbon pellet with the elastomer can occur at a temperature in a range as defined by any two of the preceding values. For example, the mixing of the treated carbon pellet with the elastomer can occur at a temperature in a range from about 80° C. to about 200° C. The increased temperature of the mixing may result in a release of at least a portion of the water contained within the treated carbon pellet from the water soluble sulfur active molecules added to the carbon particles before, during, and/or after pelletization 120. While FIG. 1 shows operational steps in an order, the operational steps may be combined and/or performed in an alternative order.

The elastomer reinforcement process 140 may comprise a mixing at an elevated (e.g., above ambient) temperature and a curing of the elastomer at an elevated temperature. The elevated temperature may be a temperature of at least about 20, 25, 30, 35, 40, 45, 50, 55, 60, 65, 70, 75, 80, 85, 90, 95, 100, 110, 120, 130, 140, 150, 160, 170, 180, 190, 200, or more degrees Celsius (° C.). The elevated temperature may be a temperature of at most about 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, or less ° C. The elevated temperature may be a temperature in a range as defined by any two of the preceding values. For example, the elevated temperature may be a temperature in a range of about 80° C. to about 200° C.

The mixing in the elastomer reinforcement process 140 may include, without limitation, use of hydrophilic acids as preferable to hydrophobic acids or acid salts. For example, during mixing, a salt may melt, and an extremely hydrophobic salt may dissolve into the elastomer matrix. This may cause the enhanced crosslinking to not occur at the carbon particle surface, but rather throughout the rubber mixture. Enhanced crosslinking at the rubber surface may improve performance, and acids or salts such as glycolic acid, formic acid, acetic acid may be preferable for this purpose due to their strong hydrophilicity which is incompatible with the hydrophobic elastomer system.

The methods of the present disclosure (e.g., example method 100) may be carried out in an inert atmosphere. The inert atmosphere may comprise low, substantially no, or no reactive gas species. For example, the method 100 may be carried out in a substantially nitrogen atmosphere. The method 100 may be carried out in an atmosphere comprising at most about 50%, 45%, 40%, 35%, 30%, 25%, 20%, 15%, 10%, 9%, 8%, 7%, 6%, 5%, 4%, 3%, 2%, 1%, 0.5%, 0.1%, 0.05%, 0.01%, 0.005%, 0.004%, 0.003%, 0.002%, 0.001%, 9 parts per million (ppm), 8 ppm, 7 ppm, 6 ppm, 5 ppm, 4 ppm, 3 ppm, 2 ppm, 1 ppm, or less oxygen by mole fraction.

In embodiments, the present disclosure provides a carbon particle (e.g., a treated, pelletized, and dried carbon particle) or treated carbon pellet comprising carbon particles or a plurality of carbon particles. The carbon particle may comprise a surface decorated with one or more water soluble sulfur active species, as described elsewhere herein.

The one or more water soluble sulfur active species on the treated (e.g., decorated) carbon particles (or pellets) may be present (loaded) at levels in a cumulative ratio (if more than one) of at least about 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 11, 12, 13, 14, 15, 16, 17, 18, 19, 20, or more percent by mass. The one or more water soluble sulfur active species may be present (loaded) at levels in a cumulative ratio (if more than one) of at most about 20, 19, 18, 17, 16, 15, 14, 13, 12, 11, 10, 9, 8, 7, 6, 5, 4.5, 4, 3.5, 3, 2.5, 2, 1.5, 1, 0.9, 0.8, 0.7, 0.6, 0.5, 0.4, 0.3, 0.2, 0.1, 0.05, 0.01, or less percent by mass. The one or more water soluble sulfur active species may be present (loaded) in a ratio within a range defined by any two of the preceding values. For example, water soluble sulfur active species may be present (loaded) at levels in a range of about 0.05 to about 0.8 percent by mass, between about 0.05 to about 1 percent by mass, etc. The mass percentage may be a total mass percentage (e.g., mass percentage of a total composition comprising the carbon particles). The mass percentage may be with respect to the carbon particles (e.g., the mass percentage of the one or more water soluble sulfur active species and the carbon particles).

The one or more water soluble sulfur active species may increase a hydrophilic spreading pressure of the carbon particle of a treated carbon pellet comprising a plurality of such carbon particles when compared to the carbon particle without the one or more water soluble sulfur active species. For example, a carbon particle of a treated carbon pellet with the one or more water soluble sulfur active species may have a higher hydrophilic spreading pressure than the same carbon particle that was not decorated with the one or more additive(s). The hydrophilic spreading pressure of the carbon particle may be increased by at least about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 110, 120, 130, 140, 150, or more percent with addition of the one or more water soluble sulfur active species. The hydrophilic spreading pressure of the carbon particle may be increased by at most about 150, 140, 130, 120, 110, 100, 95, 90, 85, 80, 75, 70, 65, 60, 55, 50, 45, 40, 35, 30, 25, 20, 19, 18, 17, 16, 15, 14, 13, 12, 11, 10, 9, 8, 7, 6, 5, 4, 3, 2, 1, or less percent with addition of the one or more water soluble sulfur active species. The hydrophilic spreading pressure of the carbon particle may be increased by an amount within a range as defined by any two of the preceding values. For example, the hydrophilic spreading pressure of the carbon particle may be increased by an amount in a range of about 10 percent to about 50 percent with the addition of (decoration with) the one or more water soluble sulfur active species.

An additive package comprising one or more water soluble sulfur active species may be configured to release water upon an elevation of the temperature of the carbon particle. For example, the additive package comprising one or more water soluble sulfur active species can be decorating the surface of a carbon particle and, upon heating of the carbon particle, release the water into an area surrounding the carbon particle. In this example, the released water can be made available as a reactive reagent in the area immediately around the carbon particle. The elevation of temperature to release the water can be performed during an elastomer reinforcement process as described elsewhere herein. For example, a carbon particle decorated with an additive package comprising one or more water soluble sulfur active species may be incorporated in a rubber mixing process. In this example, during a heating operation of the rubber mixing process, water may be released from the additive package comprising one or more water soluble sulfur active species and take part in the rubber mixing process proximal to the carbon particle.

The present disclosure may provide a treated carbon pellet comprising a plurality of carbon particles comprising a carbon particle decorated with one or more water soluble sulfur active species. The other carbon particles of the plurality of carbon particles may be the same or substantially the same as the carbon particle. For example, the carbon particles of the plurality of carbon particles may all belong to a same grade of carbon particles. In this example, the properties of the carbon particles may all fall within a range of characteristics or parameter values provided by the grade of the carbon particles.

In embodiments, the treated carbon pellet may comprise a binder. The binder may be as described elsewhere herein. For example, the binder may be lignosulfonate. In embodiments, the one or more water soluble sulfur active species can be hydrated or further hydrated by the binder or an aqueous carrier solution (e.g., water) of the binder. For example, the one or more water soluble sulfur active species can become hydrated upon exposure to a binder solution comprising water. In embodiments, the one or more water soluble sulfur active species can be hydrated prior to exposure to the binder or the carrier solution. For example, the one or more water soluble sulfur active species can be hydrated when applied to the carbon particle prior to an introduction of the binder carrier solution.

The treated carbon pellet may have a moisture (e.g., water) content of at least about 0.001, 0.005, 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.5, 4, 4.5, 5, 6, 7, 8, 9, 10, or more percent by mass. The treated carbon pellet may have a moisture content of at most about 10, 9, 8, 7, 6, 5, 4.5, 4, 3.5, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, 0.05, 0.01, 0.005, 0.001, or less percent by mass. The treated carbon pellet may have a moisture content in a range as defined by any two of the preceding values. For example, the treated carbon pellet may have a moisture content in a range of about 0.1 to about 1.5 percent by mass. In another example, the treated carbon pellet may have a moisture content of about 0.2 to about 1 percent by mass. The moisture content of the pellet may be due to the water contained within the one or more water soluble sulfur active species. For example, all or substantially all of the moisture content of the treated carbon pellet may be contained within the one or more water soluble sulfur active species. The moisture content of the treated carbon pellet may be substantially due to water or aqueous mixtures contained within the additive(s) or additive mixture comprising one or more water soluble sulfur active species. The moisture content of the treated carbon pellet may be due to a combination of the moisture contained within the dissolved one or more water soluble sulfur active species and moisture contained in different components of the treated carbon pellet.

A carbon particle of a treated carbon pellet after drying step 130 may have a surface area of at least about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, or more square meters per gram (m²/g). The carbon particle may have a surface area of at most about 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, 25, 20, 19, 18, 17, 16, 15, 14, 13, 12, 11, 10, 9, 8, 7, 6, 5, 4, 3, 2, 1, or fewer square meters per gram (m²/g). The carbon particle may have a surface area in a range as defined by any two of the preceding values. For example, the carbon particle may have a surface area in a range of about 15 m²/g to about 50 m²/g. The surface area may be a nitrogen surface area (N2SA), a statistical thickness surface area (STSA), an electron microscopy surface area (EMSA), or the like.

A carbon particle of a treated carbon pellet after drying step 130 may comprise at least about 50, 55, 60, 65, 70, 75, 80, 85, 90, 91, 92, 93, 94, 95, 96, 97, 98, 99, 99.5, 99.9, 99.99, or more percent carbon by mass. The carbon particle may comprise at most 99.99, 99.9, 99.5, 99, 98, 97, 96, 95, 94, 93, 92, 91, 90, 85, 80, 75, 70, 65, 60, 55, 50, or less percent carbon by mass. The carbon particle may comprise an amount of carbon within a range as defined by any two of the preceding values. For example, the carbon particle may comprise carbon in a range from about 90 to about 99 percent carbon by mass.

A carbon particle of a treated carbon pellet after drying step 130 may have a volume equivalent sphere diameter of at least about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, or more micrometers. The carbon particle may have a volume equivalent sphere diameter of at most about 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, or less micrometers. The carbon particle may have a volume equivalent sphere diameter in a range as defined by any two of the preceding values. For example, the carbon particle may have a volume equivalent sphere diameter in a range from about 1 micrometer to about 2 micrometers. In another example, the carbon particle may have a volume equivalent sphere diameter in a range from about 100 nanometers to about 700 nanometers. The carbon particle may have a ratio of carbon-12 atoms to carbon-14 atoms of at least about 1:10⁻²⁰, 1:10⁻¹⁹, 1:10⁻¹⁸, 1:10⁻¹⁷, 1:10⁻¹⁶, 1:10⁻¹, 1:10⁻¹⁴, 1:10⁻¹³, 1:2×10⁻¹³, 1:3×10⁻¹³, 1:4×10⁻¹³, 1:5×10⁻¹³, 1:6×10⁻¹³1:7×10⁻¹³, 1:8×10⁻¹³, 1:9×10⁻¹³, 1:10⁻¹², 1:1.1×10⁻¹², 1:1.2×10⁻¹², 1:1.3×10⁻¹², 1:1.35×10⁻¹², 1:1.4×10⁻¹², or more. The carbon particle may have a ratio of carbon-12 atoms to carbon-14 atoms of at most about 1:1.4×10⁻¹², 1:1.35×10⁻¹², 1:1.310⁻¹², 1:1.2×10⁻¹², 1:1.1×10⁻¹², 1:10⁻¹², 1:9×10⁻¹³, 1:8×10⁻¹³, 1:7×10⁻¹³, 1:6×10⁻¹³, 1:5×10⁻¹³, 1:4×10⁻¹³, 1:3×10⁻¹³, 1:2×10⁻¹³, 1:10⁻¹³, 1:10⁻¹⁴, 1:10⁻¹, 1:10⁻¹⁶, 1:10⁻¹⁷, 1:10⁻¹⁸, 1:101⁹, 1:10⁻²⁰, or less. The carbon particle may have a ratio of carbon-12 to carbon-14 atoms in a range as defined by any two of the preceding values. For example, the carbon particle may have a ratio of carbon-12 to carbon-14 atoms in a range of about 1:10⁻¹⁴ to about 1:1.5×10⁻¹³.

The plurality of carbon particles of a treated carbon pellet may comprise at least about 10, 20, 30, 40, 50, 60, 70, 80, 90, 95, 99, 99.9, or more percent carbon particles with a volume equivalent sphere diameter of less than about 2 micrometers (also referred to as nanoparticles herein). The plurality of carbon particles may comprise at most about 99.9, 99, 95, 90, 80, 70, 60, 50, 40, 30, 20, 10, or less percent carbon particles with a volume equivalent sphere diameter of less than about 2 micrometers. The plurality of carbon particles may comprise a percentage of carbon particles with a volume equivalent sphere diameter of less than about 2 micrometers in a range defined by any two of the preceding values. For example, the plurality of carbon particles may comprise from about 85 to about 99 percent carbon particles with a volume equivalent sphere diameter of less than about 2 micrometers. The volume equivalent sphere diameter may be measured by centrifugal particle sedimentation (or sedimometry). An example of volume equivalent sphere diameter determination can be found at pp. 70-78 of the book “Principles of Colloid and Surface Chemistry” (Hiemenz and Rajagopalan, Third Edition, CRC Press, 1997), which is incorporated by reference herein in its entirety.

The present disclosure may provide a composite comprising an elastomer and a carbon particle of a treated carbon pellet. In embodiments, the composite may be formed by compounding the treated carbon pellets into the elastomer. The composite may comprise the elastomer and the treated carbon pellet comprising the carbon particle. The composite may be a reinforced elastomer comprising the elastomer and the carbon particle. For example, the elastomer may be reinforced at least in part by the carbon particle. The elastomer reinforced with the carbon particle decorated with one or more water soluble sulfur active species may have an improvement in the performance properties of the elastomer composite of at least about 0.5, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, or more percent as compared to an elastomer composite that is formed with carbon particles that do not have a surface decorated with the one or more water soluble sulfur active species. Examples of material properties that can be improved with addition of the one or more water soluble sulfur active species include, but are not limited to, tensile strength, tear resistance, abrasion resistance, elastic modulus (e.g., M100, M300, and/or ratios thereof, etc.), or the like. For example, an elastomer composite reinforced with a treated carbon pellet decorated with one or more water soluble sulfur active species may provide a performance increase in the modulus at 300% elongation (M300) and/or the ratio of the modulus at 300% elongation to the modulus at 100% elongation (M300/M100) of at least about 5%. The treated carbon pellet may comprise carbon particles produced by a plasma process, a furnace process, or any other process used for the production of carbon particles (e.g., carbon black).

In embodiments, when the treated carbon particles (or the treated carbon pellets comprised thereof) are compounded with an elastomer and cured into a rubber article, the elastomer compound (rubber article) has a modulus at 300% elongation (M300) that is higher than a reference M300 of a reference elastomer compound (rubber article), by a value greater than 1, 2, 3, 5, 10, 12, or 15 times a percentage loading of the water soluble sulfur active species on the treated carbon particles, wherein the reference elastomer compound (rubber article) comprises reference carbon particles that are of a same preparation as the treated carbon particles except the reference carbon particles have no water soluble sulfur active species on a surface thereof.

In embodiments, when the treated carbon particles (or the treated carbon pellets comprised thereof) are compounded with an elastomer and cured into a rubber article, the elastomeric composite (e.g., rubber article) has a scorch time (TS1 or TS2) that is lower by at least 5, 10, 15, 20, 25, 30, 35, 40, or 50 times a loading of the water soluble sulfur active species when compared on a percentage basis to untreated carbon particles that are the same as the treated carbon particles except not having on their surface the water soluble sulfur active species.

In embodiments, when the treated carbon particles are compounded with an elastomer and cured into a rubber composite, scorch times (TS1 and TS2) of a rubber composite comprising the treated carbon particles are decreased by more than 5, 6, 7, 8, 9, 10, 11, 12, or 15%, but less than 35, 36, 37, 38, 39, 40, 41, 42, 43, 44, or 45%, compared to corresponding untreated carbon particles.

In embodiments, the water soluble sulfur active species is selected (with respect to both accelerator classification and loading levels in decorating the surface of the carbon particles) such that the scorch times (TS1 and TS2) of a rubber compound comprising the treated carbon particles have been tuned to match a reference rubber composite incorporating furnace black while simultaneously matching an M300 of the reference composite incorporating furnace black.

Examples of elastomers amenable to reinforcement using the methods and additives of the present disclosure include, but are not limited to, natural rubbers, styrene butadiene rubber, polybutadiene, polyisobutylene, polyisoprene, nitrile rubber, butyl rubber, halobutyl, ethylene propylene rubber, ethylene propylene diene rubber, silicone rubber, fluoroelastomers, or the like, or any combination thereof. Other examples of elastomers may be found at chapter 7, page 337 of “The Science and Technology of Rubber” (Mark, Erman, and Roland, Fourth Edition, Academic Press, 2013), incorporated by reference above. The elastomer may be a polymer related to natural rubber. The elastomer may have both viscous and elastic components. The elastomer also may be a chemically modified rubber, for example (but not limited to) end groups that have been carboxylated, epoxidized, etc. The middle, beginning, and end of the elastomer chain, and anywhere between, are all areas where elastomer chain modification with chemical moieties may be performed.

Dithiocarbamates and xanthates are non-limiting examples of water soluble sulfur active species of the present disclosure that can increase the polymer-filler interaction, manifested in a larger modulus at 300% elongation (M300) of the cured rubber sample containing the treated carbon particles. However, if the dithiocarbamates (or xanthates or other water soluble sulfur active species) are not strongly bound to the carbon black surface, the full benefit of increased interaction may not be achieved.

It is known that carbon disulfide (CS₂), as well as polycyclic aromatic hydrocarbon (PAH) derivatives possessing amine and alcohol groups, are present in the effluent (e.g., tail) gas stream during furnace carbon black production. As recognized in the present disclosure, it is likely that dithiocarbamates and xanthates are produced in the furnace carbon black process, either on PAHs or at the surface of the furnace carbon black. These dithiocarbamates or xanthates can enhance free radical activity at the surface of the furnace carbon black. However, these compounds are not present in the plasma pyrolysis, which differs from combustion as to both process and effluent characteristics. Instead, a synthetic pathway to make dithiocarbamates and xanthates, by mixing CS₂ with amines or alcohols, can be used. If the resulting dithiocarbamates or xanthates (or other free radical active species) can be strongly bound to the plasma carbon black surface, either by strong and multiple van der Waals interactions or through being part of the carbon black surface itself, the interaction may be much enhanced, leading to a higher M300 and/or M300/M100 ratio with potentially very little change to the cure kinetics. Stronger van der Waals forces and/or larger PAH molecules are less likely to result in desorption from the carbon black surface. To this point, methods of the present disclosure include reacting carbon disulfide (CS₂) with amines or alcohols of a hydrocarbon, hydrocarbon mixture, or hydrocarbon simulant having an average molecular weight of at least 150 g/mol and at least some sulfur, nitrogen, and oxygen present as measured in bulk. In embodiments, the liquid hydrocarbon mixture reacted with carbon disulfide (CS₂) (i) has an average molecular weight of at least 150 g/mol and (ii) comprises one or more polycyclic aromatic hydrocarbons (PAHs) functionalized with oxygen, nitrogen, or both in an individual or combined concentration of at least 0.5% by weight. Upon reaction, a dithiocarbamate, a xanthate, or both are generated and may be used to decorate a surface of carbon particles, as discussed above. Non-limiting examples of a suitable hydrocarbon, hydrocarbon mixture, or hydrocarbon simulant include carbon black oil (CBO), aminopyrene, or alcohol-functionalized pyrene, taken individually or together, to react with CS₂ to form dithiocarbamates and/or xanthates.

In embodiments, methods of the present disclosure may include reacting CBO, which is rich in amine and alcohol functionalized PAHs, with CS₂ in a basic aqueous solution, then pelletizing the carbon black with either an augmented direct spray of the PAH or an emulsion of the CBO functionalized with CS₂ to form dithiocarbamates and xanthates. In other embodiments, methods of the present disclosure may include chemically increasing the number of amine and/or alcohol groups at the CBO surface before reacting the CBO with the CS₂. These methods can result in a functionalized carbon pellet with the reactive surface chemistry that is present on furnace carbon black (and not otherwise present on plasma carbon black due to no CS₂ and very little PAH in the manufacturing process).

In embodiments, the water soluble sulfur active species of the present disclosure can be polymeric water soluble sulfur active species.

In embodiments, lignosulfonates, commonly used as binders to provide pellet integrity during shipping, may be functionalized and added at or in the pelletizer as a water soluble sulfur active species of the present disclosure. Lignosulfonates are lignin that has been heavily sulfonated to impart water solubility. A large portion of the lignin molecule is comprised of alcohol moieties. These alcohol moieties can be xanthated through the reaction with carbon disulfide (CS₂). In this way, the functionalized lignosulfonate may serve a dual purpose: as a binder, providing pellet integrity, and, as the water soluble sulfur active species, increasing the ability of the treated (decorated) carbon particle to reinforce an elastomeric composition for a rubber article.

Example A: As an example of functionalized lignosulfonate, lignosulfonate is reacted with carbon disulfide, and subsequently the carbon particles are pelletized at 0.3% loading with the functionalized lignosulfonate reaction product. In a 300 mL round bottom flask, charge with 50 grams lignosulfonate and 100 grams deionized water. Slowly add 52.5 grams of a 20% NaOH solution (0.263 mol) while stirring. Allow to stir for 30 minutes after addition is complete. Place the round bottom flask into an ice bath. Then add 19 grams (0.250 mol) of carbon disulfide dropwise to the stirring solution. Allow the reaction to warm to room temperature and fit the top of the reaction flask with a reflux condenser. Then bring to 50° C. and hold for 3-5 hours. Use this solution as the pelletization solution. Pelletize evenly with 21 kg of fluffy carbon black to effect a 0.33% loading of the water soluble sulfur active agent and then test the resultant carbon black pellets in rubber.

Other examples of polymers that can be used in a dual-purpose way include tannic acid (basified), lignin, co-polymers, etc. It can also be envisaged that polymers with primary and secondary amine functionality also may be utilized to prepare a polymeric water soluble sulfur active species. Indeed, through a Mannich type reaction, carbonyl groups on a lignosulfonate polymer can be converted to primary or secondary amines, and these groups then can be reacted with carbon disulfide (CS₂) to form dithiocarbamates (DTC). In this way, the water soluble sulfur active species can contain greater than 5, 10, or even 20 xanthates, dithiocarbamates, or mixtures thereof.

In an example method, steps may include a Mannich reaction of lignosulfonate followed by reaction with carbon disulfide and subsequent pelletization of carbon particles with the reaction product at 0.3% loading.

Example B: As another example of functionalized lignosulfonate, lignosulfonate is subjected to a Mannich reaction and then reacted with carbon disulfide, and subsequently the carbon particles are pelletized at 0.3% loading with the functionalized lignosulfonate reaction product. In a 300 mL round bottom flask, add 50 grams of lignosulfonate and 100 grams of water. To this stirring solution, add 13.5 grams of 37% formaldehyde (0.17 mol) in water. Then add 10 grams of urea (0.17 mol) and allow to stir for 1 hour before heating to 65° C. for an additional 3 hours. Dry this solution using a vacuum distillation setup at 50° C. and 300 torr to take to mostly dryness. Then add 100 grams of deionized or distilled water. Next, slowly add to the stirring solution 52.5 grams of 20 wt. % sodium hydroxide (0.263 mol) solution in water. Allow to stir for 30 minutes prior to putting the round bottom flask into an ice bath. Next add 19 grams of carbon disulfide (0.25 mol) dropwise to the stirring solution. Allow to warm to room temperature and then fit a reflux condenser onto the round bottom flask. Bring the solution to 50° C. and allow to react for 3 hours. Pelletize this solution evenly with the appropriate amount of carbon black to effect a 0.2 to 0.6% loading of this water soluble sulfur active agent and then test this pelletized carbon black in rubber.

Another type of polymer, organic heterometallic polymer systems, can be made through the formation of dithiocarbamates from basified amino acids. Examples of these types of infinite heterometallic assemblies can be formed by the combination of soft metals to bind with the dithiocarbamate moiety and hard metals that bind strongly with the carboxylate functionality. These types of assemblies can be formed from the two pen methodology (discussed above) where two different reagents are added simultaneously to the carbon black surface during pelletization. For example, zinc dithiocarbamate sodium carboxylate salt can be added with one pen, while iron dichloride is added with the second pen. The iron can displace the monovalent sodium resulting in the formation of islands of these types of species at the surface of the carbon black. Examples of amino acids that have already been shown to work for this purpose are glycine, alanine, proline, etc. For more information see Phil Köhler, Heterometallic Coordination Compounds with Amino-Acid Dithiocarbamate Ligands, Eur. J. Inorg. Chem., 28, e202500007 (Wiley-VCH GmbH Mar. 18, 2025), at https://doi.org/10.1002/ejic.202500007, incorporated by reference herein.

Systems and methods of the present disclosure may be combined with or modified by other systems and/or methods (with appropriate modification(s)), such as, for example, chemical processing and heating methods, chemical processing systems, reactors and plasma torches, and carbon particles described in U.S. Pat. No. 10,370,539 (“SYSTEM FOR HIGH TEMPERATURE CHEMICAL PROCESSING”), U.S. Pat. Pub. No. 2015/0211378 (“INTEGRATION OF PLASMA AND HYDROGEN PROCESS WITH COMBINED CYCLE POWER PLANT, SIMPLE CYCLE POWER PLANT AND STEAM METHANE REFORMERS”), U.S. Pat. No. 10,100,200 (“USE OF FEEDSTOCK IN CARBON BLACK PLASMA PROCESS”), U.S. Pat. No. 10,138,378 (“PLASMA GAS THROAT ASSEMBLY AND METHOD”), U.S. Pat. No. 9,574,086 (“PLASMA REACTOR”), U.S. Pat. No. 11,304,288 (“PLASMA TORCH DESIGN”), Int. Pat. Pub. No. WO 2016/126598 (“CARBON BLACK COMBUST[I]BLE GAS SEPARATION”), U.S. Pat. No. 11,987,712 (“CARBON BLACK GENERATING SYSTEM”), U.S. Pat. No. 10,618,026 (“REGENERATIVE COOLING METHOD AND APPARATUS”), U.S. Pat. No. 11,665,808 (“DC PLASMA TORCH ELECTRICAL POWER DESIGN METHOD AND APPARATUS”), U.S. Pat. No. 12,497,517 (“METHOD OF MAKING CARBON BLACK”), U.S. Pat. No. 11,926,743 (“SYSTEMS AND METHODS OF MAKING CARBON PARTICLES WITH THERMAL TRANSFER GAS”), U.S. Pat. No. 11,939,477 (“HIGH TEMPERATURE HEAT INTEGRATION METHOD OF MAKING CARBON BLACK”), U.S. Pat. No. 12,119,133 (“CIRCULAR FEW LAYER GRAPHENE”), U.S. Pat. No. 10,808,097 (“CARBON BLACK FROM NATURAL GAS”), U.S. Pat. No. 11,149,148 (“SECONDARY HEAT ADDITION TO PARTICLE PRODUCTION PROCESS AND APPARATUS”), U.S. Pat. No. 11,492,496 (“TORCH STINGER METHOD AND APPARATUS”), U.S. Pat. No. 11,760,884 (“CARBON PARTICLES HAVING HIGH PURITIES AND METHODS FOR MAKING SAME”), Int. Pat. Pub. No. WO 2019/046322 (“PARTICLE SYSTEMS AND METHODS”), U.S. Pat. No. 12,030,776 (“SYSTEMS AND METHODS FOR PARTICLE GENERATION”), U.S. Pat. No. 12,378,124 (“PARTICLE SYSTEMS AND METHODS”), U.S. Pat. No. 11,453,784 (“CARBON PARTICLES HAVING SPECIFIC CONTENTS OF POLYCY[C]LIC AROMATIC HYDROCARBON AND BENZO[a]PYRENE”), Int. Pat. Pub. No. WO 2022/076306 (“SYSTEMS AND METHODS FOR PROCESSING”), Int. Pat. Pub. No. WO 2023/059520 (“SYSTEMS AND METHODS FOR ELECTRIC PROCESSING”), Int. Pat. Pub. No. WO 2023/137120 (“METHODS AND SYSTEMS FOR USING SILICON-CONTAINING ADDITIVES TO PRODUCE CARBON PARTICLES”), Int. Pat. Pub. No. WO 2023/235486 (“RECYCLED FEEDSTOCKS FOR CARBON AND HYDROGEN PRODUCTION”), Int. Pat. Pub. No. WO 2024/086782 (“SYSTEMS AND METHODS FOR MODULATING REACTING FLOWS”), Int. Pat. Pub. No. WO 2024/086831 (“METHODS AND ADDITIVES TO IMPROVE PERFORMANCE OF CARBON PARTICLES IN ELASTOMER COMPOSITES”), and Int. Pat. Pub. No. WO 2024/254343 (“CARBON PARTICLE COMPOSITIONS AND METHODS OF GENERATING THE SAME”), each of which is incorporated herein by reference in its entirety.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### EXAMPLES

The following examples are illustrative of certain methods and additives described herein and are not intended to be limiting. Within the examples below, the term “accelerator” denotes the water soluble sulfur active species of the present disclosure, and the term “accelerator loading” denotes levels of surface decoration (in mass percent, measured as weight percent) with the water soluble sulfur active species of the present disclosure.

### Examples 1-5: Carbon Pellets

Experimental Carbon Black Pellet Preparation: Sodium diethyldithiocarbamate (NaDDC, a “DTC” herein) was used for pellet generation in Examples 1-5 below, in which conversion from carbon black fluffy to treated carbon black pellet (see, e.g., FIG. 1 operation 120) included decorating the carbon black particles using a pin agglomerator at the pelletization device.

Example 1: Example of a 1 pen pelletization. To 3.3 liters of water, sodium diethyldithiocarbamate trihydrate was added in the amount of 13.2 grams and stirred until fully dissolved. The pH of the resulting solution was 7.8. This solution was sprayed onto carbon black in a pin agglomerator with a feed rate of 25 kg of carbon black per hour. The resulting pellets had a moisture content of 40.1 percent and approximate accelerator loading of 0.20 weight percent on carbon black.

Example 2: To 2,921 milliliters of water, sodium diethyldithiocarbamate trihydrate was added in the amount of 19.7 grams and stirred until fully dissolved. Following dissolution, the solution was charged with 25.9 grams of a 58 percent calcium lignosulfonate solution and stirred to dissolve. The solution had a pH of 7.4 and was sprayed onto carbon black in a pin agglomerator with a feed rate of 30 kg of carbon black per hour. The resulting pellets had a moisture content of 36.6 percent and approximate accelerator loading of 0.30 weight percent on carbon black.

Example 3: To 6,626 grams of water, 39.5 grams of sodium diethyldithiocarbamate trihydrate was added and stirred to dissolve. To this solution, 51.7 grams of a 58 percent calcium lignosulfonate was added. Finally, 19.2 grams of a 52% sulfur suspension was added and stirred to incorporate. The solution had a pH of 8.0 and was sprayed onto carbon black in a pin agglomerator at a feed rate of 22 kg per hour. The resulting pellets had a moisture content of 42.6 percent. Approximate accelerator loading was 0.30 weight percent, and the final sulfur loading was 0.10 weight percent.

Example 4: This is an example of a 2 pen pelletization. A vessel containing 3,493 milliliters of water was charged with 27.6 grams of sodium diethyldithiocarbamate and stirred to dissolve. To a second vessel containing 1,167 milliliters of water, 15.0 grams of sodium lignosulfonate were added and stirred to dissolve. The pH of the resulting solutions were 7.5 and 6.7, respectively. The two solutions were simultaneously sprayed onto carbon black in a pin agglomerator with a feed rate of 21 kg of carbon black per hour through two sequential nozzles. The resulting pellets had a moisture content of 43.4 percent. The approximate final accelerator loading was 0.295 weight percent.

Example 5: A vessel containing 3.3 liters of water was charged with 25.0 grams of 40 percent sodium dimethyldithiocarbamate in water. While stirring, 25.9 grams of 58 percent sodium lignosulfonate solution were added. The final pH of solution was 7.4. This solution was sprayed onto carbon black in a pin agglomerator at a feed rate of 23 kg of carbon black per hour. The final pellets had a moisture content of 39.7 percent and approximate accelerator loading of 0.30 weight percent.

### Examples 6-10: Elastomer Reinforcement

Elastomer Reinforcement. Ingredients and preparations of elastomer compound formulations (see, e.g., FIG. 1 operation 140 and description thereof), as well as comparative rubber properties for samples comprising carbon particles with and without the dithiocarbamate (DTC) decoration of the present disclosure, are provided in Examples 6-10 below: body ply skim compound NRESP01, sidewall compound BRNRW01, and tread compound ESD01, B1105, and inner liner compound BINRIO1.

### Example 6: Body Ply Skim NRESP01

TABLE 1
Compound Formulation (Body Ply Skim NRESP01)

| | | |
|---|---|---|
| Ingredient | PHR | Wt. % |

Pass 1, Master Batch (MB)

| | | |
|---|---|---|
| Natural rubber (NR) (grade SMR L); polymer | 70 | 39.73 |
| Styrene-butadiene rubber (SBR) (grade 1502); polymer | 30 | 17.03 |
| Carbon Black; filler | 50 | 28.38 |
| ZnO; activator | 5 | 2.84 |
| Stearic Acid; activator, processing aid | 2 | 1.14 |
| Naphthenic Oil (plasticizer Ln); process oil, | 10 | 5.68 |
| processing aid | | |
| SP 1068 (phenol formaldehyde resin); tackifying resin, | 4 | 2.27 |
| processing aid | | |
| TMQ; antioxidant | 0.5 | 0.28 |
| 6PPD; antiozonant and antioxidant | 1 | 0.57 |
| Total | 172.5 | — |

Pass 2

| | | |
|---|---|---|
| Master Batch | 172.5 | — |
| MBTS; accelerator | 0.5 | 0.28 |
| TBBS; accelerator | 1 | 0.57 |
| Crystex CurePro (insoluble sulfur, 10% oil); curative | 2.2 | 1.25 |
| Total | 176.2 | 100.00 |

Summary of Mixing Steps. First Pass: add polymers (natural rubber (NR) and styrene-butadiene rubber (SBR)); mix 60 seconds. Add half carbon black; mix 60 seconds. Add half carbon black/plasticizer mix, phenolic resin, antioxidant, antiozonant; mix 60 seconds. Add stearic acid and zinc oxide; mix 60 seconds. Include cleanout step; mix until drop temperature of 150° C. is reached. Second Pass: add half of the first pass, MBTS, TBBS, Crystex CurePro, and then second half of the first pass; mix until drop temperature of 105° C. is reached.

TABLE 2
Material Composition and Mixing - First Pass

| Component | Weigh-Up 1^{st} Pass (g) |
|---|---|
| SMR-L | 560 |
| ESBR 1502 | 240 |
| Zinc Oxide | 40 |
| Stearic Acid | 16 |
| Plasticizer Ln (Naphthenic Oil) | 80 |
| SP-1068 | 32 |
| Antioxidant DQ | 4 |
| Antiozonant PD-2 | 8 |
| Carbon Black | 400 |
| Calculated Total | 1380 |

Detailed Mixing Steps. Banbury First Pass: starting temperature 70° C. and starting RPM of 40. Add polymers (SMR-L and ESBR 1502); mix 60 seconds. While mixing proceeds, manually prepare thickened oil by pouring about 25% of the carbon black (CB) into the oil. Add dry CB (remaining about 75%) by pouring down the mixer throat; mix 60 seconds. Add naphthenic oil (oil thickened with about 25% of the CB), phenolic resin, antioxidant DQ, and PD-2; mix 60 seconds. Add stearic acid and zinc oxide; mix 60 seconds. Clean ram; mix until drop temperature of 150° C. at 110 RPM is reached. Milling First Pass: set water temperature on mill to 140° F. (60° C.); mill gap gauge (a.k.a. mill roll gauge) is 1.2 mm to start.

TABLE 3
Material Composition and Mixing - Second Pass

| Component | Weigh-Up 2^{nd} Pass (g) |
|---|---|
| First pass non-productive mix | 1311 |
| Accelerator MBTS | 3.8 |
| TBBS | 0.8 |
| Crystex CurePro | 11.6 |
| Calculated Total | 1327.2 |

Banbury Second Pass: starting temperature 70° C. and starting RPM of 40. Add ingredients: half of the non-productive mix (first pass compound), then MBTS, TBBS, and Crystex CurePro, then second half of the non-productive mix. Lower ram; mix at 60 RPM until drop temperature of 105° C. is reached. Milling Second Pass: water temperature on mill at 140° F. Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges. Increase mill gap gauge to 1.2 mm for final sheeting out.

Rubber Properties. The NRESP01 body ply skim formulation was mixed with pelletized plasma pyrolysis carbon black and furnace carbon black and used to compare rubber properties. All rubber samples (denoted “P” and “N” based on plasma pyrolysis carbon black and furnace carbon black, respectively) contain 0.3% lignosulfonate to establish a baseline. This enables the assessment of how additional active ingredients, such as dithiocarbamate (DTC) (e.g., sodium diethyldithiocarbamate) and sulfur, will perform in the ply formulation. The sulfur was supplied as a basic colloidal sulfur suspension with sulfur colloidal particles in the size range of 1-10 microns. The furnace carbon black samples were acquired from a supplier; while the exact binder loading is unknown, it is common to use lignosulfonate as a binder during the pelletization process. The plasma pyrolysis carbon black samples were made by Monolith Materials, Inc.

TABLE 4
Rubber Properties (Process; Cure at 150° C.)
Cure: 150° C. for 18 min in NRESP01

| Sample ID | CBID | DTC | Sulfur | ML | MH | TS1 | TS2 | T25 | T95 | ML 1 + 4 |
|---|---|---|---|---|---|---|---|---|---|---|
| P088B | T9841 | | | 100% | 100% | 100% | 100% | 100% | 100% | 100% |
| P088F | T9841 | 0.3 | 0.2 | 102% | 108% | 76% | 71% | 71% | 68% | 101% |
| N660 | N660 | | | 104% | 105% | 74% | 77% | 78% | 87% | 101% |
| P092B | T9700 | | | 100% | 100% | 100% | 100% | 100% | 100% | 100% |
| P092F | T9700 | 0.3 | 0.3 | 104% | 107% | 81% | 74% | 74% | 71% | 102% |
| N660 | N660 | | | 104% | 104% | 70% | 72% | 74% | 88% | 100% |
| P093B | T9847 | | | 100% | 100% | 100% | 100% | 100% | 100% | 100% |
| P093F | T9847 | 0.3 | 0.3 | 101% | 106% | 81% | 77% | 77% | 75% | 99% |
| N660 | N660 | | | 99% | 102% | 75% | 78% | 80% | 90% | 95% |
| P105B | T9847 | | | 100% | 100% | 100% | 100% | 100% | 100% | 100% |
| P105D | T9847 | 0.3 | 0.3 | 101% | 110% | 75% | 72% | 73% | 72% | 98% |
| N660 | N660 | | | 100% | 100% | 73% | 76% | 77% | 88% | 96% |
| P123B | T9848 | | | 100% | 100% | 100% | 100% | 100% | 100% | 100% |
| P123G | T9848 | 0.3 | 0.1 | 107% | 111% | 75% | 69% | 69% | 64% | 103% |
| N660 | N660 | | | 100% | 100% | 73% | 75% | 76% | 87% | 96% |
| P126B | T9217 | | | 100% | 100% | 100% | 100% | 100% | 100% | 100% |
| P126G | T9217 | 0.3 | | 103% | 103% | 90% | 82% | 80% | 77% | 101% |
| N660 | N660 | | | 94% | 94% | 80% | 81% | 81% | 94% | 92% |
| P127B | T9231 | | | 100% | 100% | 100% | 100% | 100% | 100% | 100% |
| P127D | T9231 | 0.1 | | 102% | 102% | 96% | 90% | 89% | 89% | 101% |
| P127E | T9231 | 0.2 | | 102% | 103% | 92% | 85% | 83% | 79% | 100% |
| P127F | T9231 | 0.3 | | 102% | 104% | 89% | 81% | 79% | 73% | 101% |
| N660 | N660 | | | 95% | 94% | 79% | 80% | 80% | 97% | 93% |
| P131A | T9245 | | | 100% | 100% | 100% | 100% | 100% | 100% | 100% |
| P131B | T9245 | 0.1 | | 107% | 101% | 112% | 102% | 99% | 96% | 101% |
| P131C | T9245 | 0.13 | | 105% | 102% | 112% | 102% | 98% | 93% | 99% |
| P131D | T9245 | 0.15 | | 105% | 102% | 113% | 102% | 98% | 93% | 99% |
| P131E | T9245 | 0.18 | | 106% | 103% | 111% | 99% | 95% | 88% | 100% |
| P131F | T9245 | 0.2 | | 105% | 101% | 113% | 101% | 96% | 89% | 99% |
| P131G | T9245 | 0.15 | | 107% | 103% | 113% | 102% | 98% | 94% | 100% |
| N660 | N660 | | | 98% | 98% | 87% | 86% | 85% | 100% | 90% |
| P132B | T9216 | | | 100% | 100% | 100% | 100% | 100% | 100% | 100% |
| P132D | T9216 | 0.05 | | 103% | 102% | 94% | 91% | 91% | 93% | 102% |
| P132E | T9216 | 0.1 | | 103% | 99% | 95% | 90% | 88% | 89% | 101% |
| P132F | T9216 | 0.3 | | 106% | 106% | 87% | 79% | 77% | 72% | 103% |
| N660 | N660 | | | 98% | 99% | 75% | 76% | 76% | 90% | 94% |
| P133A | Blend | | | 100% | 100% | 100% | 100% | 100% | 100% | 100% |
| P133C | Blend | 0.1 | | 104% | 103% | 107% | 98% | 95% | 91% | 99% |
| P133D | Blend | 0.3 | | 105% | 106% | 94% | 85% | 82% | 73% | 99% |
| N660 | N660 | | | 95% | 98% | 87% | 86% | 86% | 96% | 90% |

TABLE 5
Rubber Properties (Process; Cure at 170° C.)
Cure: 170° C. for 11 min in NRESP01

| Sample ID | CBID | DTC | Sulfur | ML | MH | TS1 | TS2 | T25 | T95 | ML 1 + 4 |
|---|---|---|---|---|---|---|---|---|---|---|
| P084A | T9556 | | | 100% | 100% | 100% | 100% | 100% | 100% | 100% |
| P084H | T9556 | 0.2 | 0.2 | 110% | 112% | 85% | 78% | 79% | 71% | 107% |
| P084I | T9556 | 0.2 | 0.5 | 108% | 116% | 81% | 75% | 77% | 70% | 104% |
| P084J | T9556 | 0.2 | 0.2 | 107% | 112% | 85% | 77% | 79% | 75% | 105% |
| P084K | T9556 | 0.2 | 0.5 | 109% | 112% | 81% | 75% | 76% | 72% | 104% |
| N660 | N660 | | | 109% | 110% | 75% | 77% | 80% | 85% | 101% |

TABLE 6
Rubber Properties (Properties; Cure at 150° C.)
Cure: 150° C. for 18 min in NRESP01

| Sample ID | CBID | DTC | Sulfur | M100 | M300 | M300/M100 | Tensile | Elongation | Shore A | Dispersion |
|---|---|---|---|---|---|---|---|---|---|---|
| P088B | T9841 | | | 100% | 100% | 100% | 100% | 100% | 100% | 100% |
| P088F | T9841 | 0.3 | 0.2 | 114% | 118% | 103% | 92% | 86% | 102% | 99% |
| N660 | N660 | | | 116% | 126% | 109% | 115% | 98% | 103% | 98% |
| P092B | T9700 | | | 100% | 100% | 100% | 100% | 100% | 100% | 100% |
| P092F | T9700 | 0.3 | 0.3 | 112% | 114% | 102% | 93% | 89% | 104% | 100% |
| N660 | N660 | | | 113% | 128% | 112% | 105% | 92% | 106% | 95% |
| P093B | T9847 | | | 100% | 100% | 100% | 100% | 100% | 100% | 100% |
| P093F | T9847 | 0.3 | 0.3 | 113% | 114% | 101% | 104% | 96% | 103% | 101% |
| N660 | N660 | | | 111% | 123% | 110% | 112% | 97% | 105% | 100% |
| P105B | T9847 | | | 100% | 100% | 100% | 100% | 100% | 100% | 100% |
| P105D | T9847 | 0.3 | 0.3 | 116% | 117% | 101% | 104% | 94% | 104% | 101% |
| N660 | N660 | | | 111% | 123% | 111% | 111% | 97% | 105% | 98% |
| P123B | T9848 | | | 100% | 100% | 100% | 100% | 100% | 100% | 100% |
| P123G | T9848 | 0.3 | 0.1 | 119% | 119% | 100% | 97% | 89% | 105% | 101% |
| N660 | N660 | | | 107% | 118% | 110% | 104% | 94% | 105% | 100% |
| P126B | T9217 | | | 100% | 100% | 100% | 100% | 100% | 100% | 100% |
| P126G | T9217 | 0.3 | | 109% | 109% | 100% | 102% | 97% | 104% | 100% |
| N660 | N660 | | | 104% | 112% | 108% | 102% | 96% | 103% | 98% |
| P127B | T9231 | | | 100% | 100% | 100% | 100% | 100% | 100% | 100% |
| P127D | T9231 | 0.1 | | 105% | 107% | 102% | 103% | 99% | 100% | 99% |
| P127E | T9231 | 0.2 | | 108% | 108% | 100% | 91% | 91% | 102% | 100% |
| P127F | T9231 | 0.3 | | 110% | 112% | 102% | 101% | 95% | 102% | 99% |
| N660 | N660 | | | 103% | 110% | 107% | 100% | 97% | 101% | 90% |
| P131A | T9245 | | | 100% | 100% | 100% | 100% | 100% | 100% | 100% |
| P131B | T9245 | 0.1 | | 100% | 101% | 101% | 103% | 101% | 99% | 100% |
| P131C | T9245 | 0.13 | | 103% | 105% | 102% | 107% | 102% | 101% | 102% |
| P131D | T9245 | 0.15 | | 102% | 105% | 103% | 99% | 96% | 100% | 102% |
| P131E | T9245 | 0.18 | | 105% | 107% | 102% | 106% | 100% | 102% | 103% |
| P131F | T9245 | 0.2 | | 102% | 104% | 102% | 106% | 101% | 100% | 103% |
| P131G | T9245 | 0.15 | | 103% | 105% | 101% | 102% | 100% | 101% | 102% |
| N660 | N660 | | | 104% | 114% | 109% | 105% | 97% | 101% | 98% |
| P132B | T9216 | | | 100% | 100% | 100% | 100% | 100% | 100% | 100% |
| P132D | T9216 | 0.05 | | 104% | 104% | 100% | 94% | 94% | 100% | 100% |
| P132E | T9216 | 0.1 | | 101% | 102% | 101% | 101% | 99% | 102% | 101% |
| P132F | T9216 | 0.3 | | 113% | 112% | 100% | 102% | 95% | 103% | 100% |
| N660 | N660 | | | 110% | 120% | 109% | 107% | 96% | 103% | 96% |
| P133A | Blend | | | 100% | 100% | 100% | 100% | 100% | 100% | 100% |
| P133C | Blend | 0.1 | | 106% | 106% | 100% | 102% | 97% | 100% | 100% |
| P133D | Blend | 0.3 | | 112% | 112% | 101% | 99% | 92% | 101% | 101% |
| N660 | N660 | | | 107% | 114% | 106% | 106% | 98% | 102% | 99% |

TABLE 7
Rubber Properties (Properties; Cure at 170° C.)
Cure: 170° C. for 11 min in NRESP01

| Sample ID | CBID | DTC | Sulfur | M100 | M300 | M300/M100 | Tensile | Elongation | Shore A | Dispersion |
|---|---|---|---|---|---|---|---|---|---|---|
| P084A | T9556 | | | 100% | 100% | 100% | 100% | 100% | 100% | 100% |
| P084H | T9556 | 0.2 | 0.2 | 111% | 113% | 102% | 97% | 93% | 108% | 100% |
| P084I | T9556 | 0.2 | 0.5 | 121% | 122% | 101% | 93% | 86% | 110% | 100% |
| P084J | T9556 | 0.2 | 0.2 | 111% | 112% | 101% | 104% | 98% | 106% | 100% |
| P084K | T9556 | 0.2 | 0.5 | 117% | 118% | 100% | 97% | 90% | 108% | 100% |
| N660 | N660 | | | 125% | 139% | 112% | 111% | 90% | 112% | 94% |

### Example 7: Sidewall BRNRW01

TABLE 8
Compound Formulation (Sidewall BRNRW01)

| | | |
|---|---|---|
| Ingredient | PHR | Wt. % |

Pass 1 mixing stage, Master Batch (MB)

| | | |
|---|---|---|
| Natural rubber (NR) (SMR-L); polymer | 40 | 21.39 |
| Butadiene rubber (BR) (Diene 140ND); polymer | 60 | 32.09 |
| Carbon Black; filler | 55 | 29.41 |
| Naphthenic oil (Plasticizer ln); process oil, processing | 10.5 | 5.61 |
| aid | | |
| Zinc Oxide; activator | 2.5 | 1.34 |
| TMQ (Antioxidant DQ); antioxidant | 6.5 | 3.48 |
| Stearic Acid; activator, processing aid | 1.5 | 0.80 |
| C5 resin (C595); tackifying resin, processing aid | 7 | 3.74 |
| Total | 183 | — |

Pass 2 mixing stage

| | | |
|---|---|---|
| Master Batch (MB) from Pass 1 | 183 | — |
| 6PPD (Antiozonant PD-2); antiozonant/antioxidant | 1 | 0.53 |
| TBBS; accelerator | 1 | 0.53 |
| Sulfur; crosslinker/curative | 2 | 1.07 |
| Total | 187 | 100.00 |

Summary of Mixing Steps. First Pass: add polymers (natural rubber (NR) and butadiene rubber (BR)); mix 30 seconds; add carbon black; mix 60 seconds; add naphthenic oil, phenolic resin, and stearic acid; mix 30 seconds; include two ram clean-out steps at 30 seconds each; mix until drop temperature of 125° C. is reached. Second Pass: add first pass mix plus zinc oxide, sulfur, and TBBS; mix until drop temperature of 105° C. is reached.

TABLE 9
Material Composition and Mixing - First Pass

| Component | Weigh-Up 1^{st} Pass (g) |
|---|---|
| SMR-L | 300 |
| Diene 140ND [butadiene] | 450 |
| Plasticizer In [naphthenic oil] | 78.8 |
| Zinc Oxide | 18.8 |
| Antioxidant DQ | 48.8 |
| Stearic Acid | 11.3 |
| C595 Resin [phenolic resin] | 52.5 |
| Carbon Black | 412.5 |
| Calculated Total | 1372.5 |

Detailed Mixing Steps. Banbury First Pass: starting temperature of 45° C. and starting RPM (rotations per minute) of 30. Add polymers (e.g., SMR-L and Diene 140ND); mix for 30 seconds. While mixing proceeds, manually prepare thickened oil by pouring about 25% of the carbon black (CB) into the oil. Add dry CB (remaining about 75%) by pouring down the mixer throat; mix for 60 seconds. Add naphthenic oil (oil thickened with about 25% of the CB). Add zinc oxide, antioxidant DQ, stearic acid, and resin C595; mix for 30 seconds. Clean ram; mix for 25 seconds. Clean ram; mix until a drop temperature of 125° C. at 90 RPM is reached. Milling First Pass: set water temperature on the mill to 80° F. (~27° C.); mill gap gauge (a.k.a. mill roll gauge) is 1.2 mm to start.

TABLE 10
Material Composition and Mixing - Second Pass

| Component | Weigh-Up 2^{nd} Pass (g) |
|---|---|
| First pass non-productive mix | 1281 |
| Antiozonant PD-2 | 7 |
| TBBS | 7 |
| Sulfur | 14 |
| Calculated Total | 1309 |

Banbury Second Pass: starting temperature of 45° C. and starting RPM of 30. Add ingredients: add non-productive mix (first pass compound); add antiozonant PD-2, TBBS, sulfur. Lower ram; mix at 90 RPM until a drop temperature of 105° C. is reached. Milling Second Pass: set water temperature on mill to 80° F. (−27° C.). Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 8 such pig rolls, alternating starting edges. Increase mill gap gauge to 1.2 mm for final sheeting out.

Rubber Properties. The BRNRW01 sidewall formulation was mixed with pelletized plasma pyrolysis carbon black and furnace carbon black and used to compare rubber properties. All rubber samples (denoted “P” and “N” based on plasma pyrolysis carbon black and furnace carbon black, respectively) contain 0.3% lignosulfonate to establish a baseline. This enables the assessment of how additional active ingredients, such as DTC (e.g., sodium diethyldithiocarbamate) and sulfur, will perform in the ply formulation. The furnace carbon black samples were acquired from a supplier; while the exact binder loading is unknown, it is common to use lignosulfonate as a binder during the pelletization process. The plasma pyrolysis carbon black samples were made by Monolith Materials, Inc.

TABLE 11
Rubber Properties (Process)
Cure: 160° C. for T95 + 2 min in BRNRW01

| Sample ID | CBID | DTC | Sulfur | ML | MH | TS1 | TS2 | T25 | T95 | ML 1 + 4 |
|---|---|---|---|---|---|---|---|---|---|---|
| P084A | T9556 | | | 100% | 100% | 100% | 100% | | 100% | 100% |
| P084H | T9556 | 0.2 | 0.2 | 107% | 118% | 93% | 90% | | 77% | 102% |
| P084I | T9556 | 0.2 | 0.5 | 108% | 117% | 89% | 86% | | 74% | 104% |
| P084J | T9556 | 0.2 | 0.2 | 108% | 110% | 94% | 90% | | 80% | 103% |
| P084K | T9556 | 0.2 | 0.5 | 105% | 113% | 88% | 84% | | 75% | 100% |
| N660 | N660 | | | 112% | 109% | 83% | 86% | | 82% | 105% |
| P088B | T9841 | | | 100% | 100% | 100% | 100% | | 100% | 100% |
| P088F | T9841 | 0.3 | 0.2 | 103% | 108% | 75% | 72% | | 72% | 107% |
| N660 | N660 | | | 112% | 103% | 76% | 78% | | 88% | 103% |
| P092B | T9700 | | | 100% | 100% | 100% | 100% | 100% | 100% | 100% |
| P092F | T9700 | 0.3 | 0.3 | 101% | 112% | 84% | 81% | 81% | 77% | 101% |
| N660 | N660 | | | 114% | 102% | 83% | 86% | 86% | 90% | 106% |
| P093B | T9847 | | | 100% | 100% | 100% | 100% | 100% | 100% | 100% |
| P093F | T9847 | 0.3 | 0.3 | 106% | 115% | 74% | 71% | 72% | 72% | 102% |
| N660 | N660 | | | 112% | 100% | 75% | 77% | 78% | 86% | 104% |
| P105B | T9847 | | | 100% | 100% | 100% | 100% | 100% | 100% | 100% |
| P105D | T9847 | 0.3 | 0.3 | 102% | 114% | 77% | 75% | 75% | 76% | 100% |
| N660 | N660 | | | 110% | 103% | 77% | 79% | 79% | 84% | 0% |
| P126B | T9217 | | | 100% | 100% | 100% | 100% | 100% | 100% | 100% |
| P126G | T9217 | 0.3 | | 104% | 112% | 90% | 84% | 83% | 81% | 104% |
| N660 | N660 | | | 102% | 96% | 79% | 80% | 80% | 88% | 101% |
| P127B | T9231 | | | 100% | 100% | 100% | 100% | 100% | 100% | 100% |
| P127D | T9231 | 0.1 | | 102% | 101% | 106% | 100% | 99% | 98% | 101% |
| P127E | T9231 | 0.2 | | 101% | 107% | 96% | 90% | 89% | 86% | 100% |
| P127F | T9231 | 0.3 | | 103% | 113% | 88% | 82% | 81% | 77% | 101% |
| N660 | N660 | | | 98% | 98% | 80% | 81% | 81% | 88% | 96% |
| P133A | Blend | | | 100% | 100% | 100% | 100% | 100% | 100% | 100% |
| P133C | Blend | 0.1 | | 102% | 102% | 107% | 102% | 101% | 94% | 101% |
| P133D | Blend | 0.3 | | 104% | 110% | 93% | 86% | 84% | 76% | 102% |
| N660 | N660 | | | 104% | 95% | 90% | 90% | 89% | 91% | 101% |

TABLE 12
Rubber Properties (Properties)
Cure: 160° C. for T95 + 2 min in BRNRW01

| Sample ID | CBID | DTC | Sulfur | M100 | M300 | M300/M100 | Tensile | Elongation | Shore A | Dispersion |
|---|---|---|---|---|---|---|---|---|---|---|
| P084A | T9556 | | | 100% | 100% | 100% | 100% | 100% | 100% | 100% |
| P084H | T9556 | 0.2 | 0.2 | 122% | 122% | 100% | 98% | 91% | 104% | 100% |
| P084I | T9556 | 0.2 | 0.5 | 120% | 121% | 100% | 102% | 93% | 104% | 99% |
| P084J | T9556 | 0.2 | 0.2 | 113% | 111% | 98% | 107% | 101% | 103% | 100% |
| P084K | T9556 | 0.2 | 0.5 | 115% | 111% | 97% | 97% | 94% | 102% | 100% |
| N660 | N660 | | | 111% | 119% | 107% | 110% | 97% | 103% | 81% |
| P088B | T9841 | | | 100% | 100% | 100% | 100% | 100% | 100% | |
| P088F | T9841 | 0.3 | 0.2 | 125% | 124% | 100% | 97% | 88% | 88% | |
| N660 | N660 | | | 105% | 115% | 109% | 111% | 100% | 100% | |
| P092B | T9700 | | | 100% | 100% | 100% | 100% | 100% | 100% | 100% |
| P092F | T9700 | 0.3 | 0.3 | 121% | 119% | 98% | 89% | 82% | 103% | 99% |
| N660 | N660 | | | 100% | 110% | 110% | 105% | 96% | 99% | 75% |
| P093B | T9847 | | | 100% | 100% | 100% | 100% | 100% | 100% | 100% |
| P093F | T9847 | 0.3 | 0.3 | 126% | 127% | 101% | 108% | 92% | 107% | 99% |
| N660 | N660 | | | 103% | 111% | 108% | 107% | 96% | 100% | 91% |
| P105B | T9847 | | | 100% | 100% | 100% | 100% | 100% | 100% | 100% |
| P105D | T9847 | 0.3 | 0.3 | 120% | 121% | 100% | 100% | 91% | 109% | 99% |
| N660 | N660 | | | 103% | 116% | 112% | 115% | 98% | 0% | 0% |
| P126B | T9217 | | | 100% | 100% | 100% | 100% | 100% | 100% | 100% |
| P126G | T9217 | 0.3 | | 119% | 119% | 100% | 100% | 91% | 108% | 99% |
| N660 | N660 | | | 95% | 101% | 106% | 103% | 100% | 98% | 70% |
| P127B | T9231 | | | 100% | 100% | 100% | 100% | 100% | 100% | 100% |
| P127D | T9231 | 0.1 | | 108% | 106% | 99% | 107% | 102% | 102% | 101% |
| P127E | T9231 | 0.2 | | 116% | 114% | 99% | 113% | 102% | 106% | 101% |
| P127F | T9231 | 0.3 | | 124% | 125% | 100% | 110% | 96% | 104% | 100% |
| N660 | N660 | | | 110% | 121% | 110% | 110% | 96% | 104% | 82% |
| P133A | Blend | | | 100% | 100% | 100% | 100% | 100% | 100% | 100% |
| P133C | Blend | 0.1 | | 104% | 104% | 100% | 101% | 99% | 101% | 99% |
| P133D | Blend | 0.3 | | 124% | 123% | 99% | 100% | 89% | 107% | 99% |
| N660 | N660 | | | 101% | 107% | 106% | 103% | 97% | 102% | 81% |

### Example 8: Tread ESD01

TABLE 13
Compound Formulation (Tread ESD01)

| Ingredient | PHR | Wt. % |
|---|---|---|
| SBR 1502; polymer | 100 | 63.80 |
| Zinc Oxide; activator | 3 | 1.91 |
| Sulfur Powder; curative | 1.75 | 1.12 |
| TBBS; accelerator | 1 | 0.64 |
| Stearic Acid; activator, processing aid | 1 | 0.64 |
| Carbon Black; filler | 50 | 31.90 |
| Total | 156.75 | 100.00 |

Summary of Mixing Steps. Modified ASTM standard compound for testing carbon black in SBR by substituting SBR 1502 for SBR 1500. First pass: add half SBR, zinc oxide, stearic acid, then second half SBR; mix for 30 seconds at 30 RPM. Add carbon black and sulfur; mix at 30 RPM until drop temperature of 100° C. is reached. Second pass: mixing occurs on the two-roll mill where TBBS is added.

TABLE 14
Material Composition and Mixing

| Component | Weigh-Up (g) |
|---|---|
| SBR 1502 | 900 |
| Zinc Oxide | 27 |
| Sulfur Powder | 15.8 |
| TBBS | 9 |
| Stearic Acid | 9 |
| Carbon Black | 450 |
| Calculated Total | 1410.8 |

Detailed Mixing Steps. Banbury: starting temperature 15° C. and starting RPM of 30. Add half of polymer (SBR 1502), zinc oxide, stearic acid, and then the second half of SBR 1502; mix 15 seconds. Add carbon black and sulfur; mix 30 seconds. Clean ram; mix 25 seconds. Clean ram; mix at 30 RPM until drop temperature of 100° C. is reached. Milling: make sure chiller is on and set to 45° F. (7° C.); mill roll gauge is 1.2 mm to start. Pig rolling: mix the TBBS into the bank of the roll. Set the mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges. Increase mill gap gauge to 1.2 mm for final sheeting out.

Rubber Properties. The ESD01 tread formulation was mixed with pelletized plasma pyrolysis carbon black and furnace carbon black and used to compare rubber properties. All rubber samples (denoted “P” and “N” based on plasma pyrolysis carbon black and furnace carbon black, respectively) contain 0.3% lignosulfonate to establish a baseline. This enables the assessment of how additional active ingredients, such as DTC (e.g., sodium diethyldithiocarbamate) and sulfur, will perform in the ply formulation. The furnace carbon black samples were acquired from a supplier; while the exact binder loading is unknown, it is common to use lignosulfonate as a binder during the pelletization process. The plasma pyrolysis carbon black samples were made by Monolith Materials, Inc.

TABLE 15
Rubber Properties (Process)
Cure: 160° C. for T95 + 2 min in ESD01

| Sample ID | CBID | DTC | Sulfur | ML | MH | TS1 | TS2 | T25 | T95 | ML 1 + 4 |
|---|---|---|---|---|---|---|---|---|---|---|
| P092B | T9700 | | | 100% | 100% | 100% | 100% | 100% | 100% | 100% |
| P092F | T9700 | 0.3 | 0.3 | 98% | 108% | 77% | 74% | 75% | 70% | 98% |
| N660 | N660 | | | 118% | 108% | 60% | 78% | 88% | 98% | 112% |
| P093B | T9847 | | | 100% | 100% | 100% | 100% | 100% | 100% | 100% |
| P093F | T9847 | 0.3 | 0.3 | 102% | 108% | 76% | 71% | 71% | 70% | 100% |
| N660 | N660 | | | 112% | 101% | 63% | 74% | 78% | 92% | 104% |
| P105B | T9847 | | | 100% | 100% | 100% | 100% | 100% | 100% | 100% |
| P105D | T9847 | 0.3 | 0.3 | 102% | 111% | 77% | 74% | 75% | 72% | 99% |
| N660 | N660 | | | 110% | 105% | 63% | 71% | 75% | 87% | 102% |
| P133A | Blend | | | 100% | 100% | 100% | 100% | 100% | 100% | 100% |
| P133C | Blend | 0.1 | | 104% | 102% | 89% | 87% | 88% | 88% | 102% |
| P133D | Blend | 0.3 | | 107% | 109% | 79% | 75% | 75% | 69% | 105% |
| N660 | N660 | | | 112% | 106% | 66% | 83% | 91% | 98% | 108% |

TABLE 16
Rubber Properties (Properties)
Cure: 160° C. for T95 + 2 min in ESD01

| Sample ID | CBID | DTC | Sulfur | M100 | M300 | M300/M100 | Tensile | Elongation | Shore A | Dispersion |
|---|---|---|---|---|---|---|---|---|---|---|
| P092B | T9700 | | | 100% | 100% | 100% | 100% | 100% | 100% | 100% |
| P092F | T9700 | 0.3 | 0.3 | 110% | 112% | 102% | 87% | 81% | 102% | 101% |
| N660 | N660 | | | 127% | 138% | 109% | 111% | 84% | 105% | 56% |
| P093B | T9847 | | | 100% | 100% | 100% | 100% | 100% | 100% | 100% |
| P093F | T9847 | 0.3 | 0.3 | 116% | 120% | 103% | 89% | 77% | 103% | 101% |
| N660 | N660 | | | 119% | 130% | 109% | 112% | 86% | 105% | 79% |
| P105B | T9847 | | | 100% | 100% | 100% | 100% | 100% | 100% | 100% |
| P105D | T9847 | 0.3 | 0.3 | 113% | 114% | 101% | 96% | 85% | 102% | 100% |
| N660 | N660 | | | 118% | 131% | 111% | 117% | 87% | 104% | 87% |
| P133A | Blend | | | 100% | 100% | 100% | 100% | 100% | 100% | 100% |
| P133C | Blend | 0.1 | | 104% | 105% | 101% | 97% | 94% | 100% | 100% |
| P133D | Blend | 0.3 | | 115% | 116% | 100% | 99% | 90% | 102% | 98% |
| N660 | N660 | | | 128% | 134% | 105% | 110% | 87% | 104% | 62% |

### Example 9: Inner Liner BII05

TABLE 17
Compound Formulation (Inner Liner BII05)

| | | | |
|---|---|---|---|
| Ingredient | Detail | PHR | Wt. % |

Pass 1, Master Batch (MB)

| | | | |
|---|---|---|---|
| BIIR | Exxon Bromobutyl 2222; polymer | 100 | 52.1 |
| Naphthenic Oil | Plasticizer ln; process oil, | 8 | 4.17 |
| | processing aid | | |
| Blk | Carbon Black; filler | 68.5 | 35.7 |
| Hydrocarbon | Proaid AC-740; tackifying resin; | 7 | 3.65 |
| Resin | processing aid | | |
| Phenolic Resin | SP 1068 (P-90) Resin; curative, | 4 | 2.08 |
| | tackifying resin | | |
| Stearic Acid | Stearic Acid-Rubbergrade; activator, | 1 | 0.52 |
| | processing aid | | |

| | | |
|---|---|---|
| Total | 188.5 | — |

Pass 2

| | | | |
|---|---|---|---|
| MB | Master Batch | 188.5 | — |
| Zinc | Zinc Oxide RGT-M; activator, curative | 1 | 0.52 |
| MgO | Magnesium Oxide; activator, acid | 0.6 | 0.31 |
| | acceptor, anti-scorch aid | | |
| Sulfur | Rubbermakers sulfur; curative | 0.5 | 0.26 |
| Accel | MBTS; accelerator | 1.3 | 0.68 |

| | | |
|---|---|---|
| Total | 191.9 | 100.00 |

Summary of Mixing Steps. First Pass: add polymer and hydrocarbon resin blend (Exxon Bromobutyl 2222 and Proaid AC-740); mix 30 seconds. Add carbon black; mix 60 seconds. Add naphthenic oil, phenolic resin, and stearic acid; mix 30 seconds. Include two ram clean-out steps at 30 seconds each; mix until drop temperature of 160° C. is reached. Second Pass: add first pass mix plus zinc oxide, sulfur, and MBTS; mix until drop temperature of 105° C. is reached.

TABLE 18
Material Composition and Mixing - First Pass

| Component | Weigh-Up 1^{st} Pass (g) |
|---|---|
| Exxon Bromobutyl 2222 | 709.4 |
| Naphthenic Oil (Plasticizer ln) | 56.8 |
| Stearic Acid | 7.1 |
| Phenolic Resin Tackifier (SP 1068) | 28.4 |
| Proaid AC-740 | 49.7 |
| Carbon Black | 485.9 |
| Calculated Total | 1337.3 |

Detailed Mixing Steps. Banbury First Pass: starting temperature 45° C. and starting RPM of 30. Add Proaid AC-740 and Exxon Bromobutyl 2222; mix 30 seconds. While mixing proceeds, manually prepare thickened oil by pouring about 25% of the carbon black (CB) into the oil. Add dry CB (remaining about 75%) by pouring down the mixer throat; mix 60 seconds. Add naphthenic oil (oil thickened with about 25% of the CB). Add phenolic resin (SP1068) and stearic acid; mix 30 seconds. Clean ram; mix 25 seconds. Clean ram; mix until a drop temperature of 160° C. at 90 RPM is reached. Milling First Pass: make sure chiller unit is on and flowing 45° F. (7° C.) water through the rolls; mill gap gauge (a.k.a. mill roll gauge) is 1.2 mm to start.

TABLE 19
Material Composition and Mixing - Second Pass

| Component | Weigh-Up 2^{nd} Pass (g) |
|---|---|
| First pass non-productive mix | 1319.5 |
| Sulfur | 3.5 |
| MBTS | 9.1 |
| Zinc Oxide | 7.0 |
| Magnesium Oxide | 4.2 |
| Calculated Total | 1343.3 |

Banbury Second Pass: starting temperature of 45° C. and starting RPM of 30. Add ingredients: non-productive mix (first pass compound); sulfur, MBTS, zinc oxide. Lower ram; mix at 90 RPM until a drop temperature of 105° C. is reached. Milling Second Pass: chill the mill rolls via chiller set to 45° F. (7° C.). Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges. Increase mill gap gauge to 1.2 mm for final sheeting out.

Rubber Properties. The BII05 inner liner formulation was mixed with pelletized plasma pyrolysis carbon black and furnace carbon black and used to compare rubber properties. All rubber samples (denoted “P” and “N” based on plasma pyrolysis carbon black and furnace carbon black, respectively) contain 0.3% lignosulfonate to establish a baseline. This enables the assessment of how additional active ingredients, such as DTC (e.g., sodium diethyldithiocarbamate) and sulfur, will perform in the ply formulation. The furnace carbon black samples were acquired from a supplier; while the exact binder loading is unknown, it is common to use lignosulfonate as a binder during the pelletization process. The plasma pyrolysis carbon black samples were made by Monolith Materials, Inc.

TABLE 20
Rubber Properties (Process)
Cure: 170° C. for 23 min in BII05

| Sample ID | CBID | DTC | Sulfur | ML | MH | TS1 | TS2 | T25 | T95 | ML 1 + 4 |
|---|---|---|---|---|---|---|---|---|---|---|
| P105B | T9847 | | | 100% | 100% | 100% | 100% | 100% | 100% | 100% |
| P105D | T9847 | 0.3 | 0.3 | 123% | 110% | 78% | 74% | 78% | 80% | 109% |
| N660 | N660 | | | 108% | 102% | 92% | 92% | 92% | 97% | 99% |
| P120B | T10990 | | | 100% | 100% | 100% | 100% | 100% | 100% | 100% |
| P120G | T10990 | 0.3 | | 103% | 110% | 73% | 75% | 78% | 94% | 101% |
| P120H | T10990 | | 0.1 | 102% | 102% | 92% | 91% | 92% | 93% | 101% |
| P120K | T10990 | 0.3 | 0.1 | 104% | 113% | 89% | 89% | 98% | 102% | 103% |
| N772 | N772 | | | 98% | 103% | 92% | 93% | 94% | 99% | 97% |
| P123B | T9848 | | | 100% | 100% | 100% | 100% | 100% | 100% | 100% |
| P123G | T9848 | 0.3 | 0.1 | 136% | 113% | 67% | 66% | 68% | 83% | 113% |
| N660 | N660 | | | 106% | 105% | 85% | 87% | 89% | 108% | 97% |
| P126B | T9217 | | | 100% | 100% | 100% | 100% | 100% | 100% | 100% |
| P126G | T9217 | 0.3 | | 111% | 112% | 75% | 73% | 80% | 85% | 104% |
| N660 | N660 | | | 97% | 101% | 95% | 95% | 96% | 101% | 91% |
| P127B | T9231 | | | 100% | 100% | 100% | 100% | 100% | 100% | 100% |
| P127D | T9231 | 0.1 | | 101% | 103% | 86% | 87% | 87% | 93% | 100% |
| P127E | T9231 | 0.2 | | 106% | 105% | 79% | 78% | 79% | 87% | 102% |
| P127F | T9231 | 0.3 | | 110% | 102% | 79% | 78% | 76% | 85% | 104% |
| N660 | N660 | | | 95% | 97% | 98% | 99% | 96% | 104% | 92% |
| P131A | T9245 | | | 100% | 100% | 100% | 100% | 100% | 100% | 100% |
| P131B | T9245 | 0.1 | | 100% | 103% | 97% | 95% | 97% | 100% | 98% |
| P131C | T9245 | 0.13 | | 101% | 102% | 93% | 91% | 92% | 99% | 98% |
| P131D | T9245 | 0.15 | | 104% | 108% | 77% | 75% | 80% | 89% | 101% |
| P131E | T9245 | 0.18 | | 109% | 99% | 106% | 102% | 100% | 101% | 101% |
| P131F | T9245 | 0.2 | | 104% | 100% | 96% | 95% | 93% | 104% | 99% |
| P131G | T9245 | 0.15 | | 107% | 106% | 74% | 73% | 76% | 90% | 102% |
| N660 | N660 | | | 99% | 96% | 103% | 102% | 97% | 110% | 95% |
| P132B | T9216 | | | 100% | 100% | 100% | 100% | 100% | 100% | 100% |
| P132D | T9216 | 0.05 | | 100% | 103% | 97% | 95% | 97% | 100% | 98% |
| P132E | T9216 | 0.1 | | 101% | 102% | 93% | 91% | 92% | 99% | 98% |
| P132F | T9216 | 0.3 | | 104% | 108% | 77% | 75% | 80% | 89% | 101% |
| N660 | N660 | | | 95% | 99% | 94% | 93% | 93% | 103% | 92% |
| P133A | Blend | | | 100% | 100% | 100% | 100% | 100% | 100% | 100% |
| P133C | Blend | 0.1 | | 95% | 100% | 91% | 93% | 93% | 103% | 98% |
| P133D | Blend | 0.3 | | 98% | 107% | 70% | 72% | 76% | 89% | 101% |
| N660 | N660 | | | 91% | 97% | 97% | 100% | 97% | 108% | 94% |

TABLE 21
Rubber Properties (Properties)
Cure: 170° C. for 23 min in BII05

| Sample ID | CBID | DTC | Sulfur | M100 | M300 | M300/M100 | Tensile | Elongation | Shore A | Dispersion |
|---|---|---|---|---|---|---|---|---|---|---|
| P105B | T9847 | | | 100% | 100% | 100% | 100% | 100% | 100% | 100% |
| P105D | T9847 | 0.3 | 0.3 | 118% | 124% | 105% | 112% | 93% | 97% | 99% |
| N660 | N660 | | | 112% | 127% | 114% | 121% | 93% | 103% | 91% |
| P120B | T10990 | | | 100% | 100% | 100% | 100% | 100% | 100% | 100% |
| P120G | T10990 | 0.3 | | 107% | 114% | 106% | 103% | 95% | 100% | 99% |
| P120H | T10990 | | 0.1 | 103% | 110% | 107% | 105% | 96% | 99% | 98% |
| P120K | T10990 | 0.3 | 0.1 | 112% | 120% | 107% | 105% | 94% | 102% | 100% |
| N772 | N772 | | | 108% | 110% | 102% | 94% | 96% | 103% | 100% |
| P123B | T9848 | | | 100% | 100% | 100% | 100% | 100% | 100% | 100% |
| P123G | T9848 | 0.3 | 0.1 | 120% | 134% | 112% | 117% | 88% | 97% | 100% |
| N660 | N660 | | | 109% | 123% | 113% | 116% | 86% | 105% | 96% |
| P126B | T9217 | | | 100% | 100% | 100% | 100% | 100% | 100% | 100% |
| P126G | T9217 | 0.3 | | 112% | 116% | 104% | 102% | 94% | 98% | 97% |
| N660 | N660 | | | 106% | 110% | 103% | 113% | 102% | 104% | 96% |
| P127B | T9231 | | | 100% | 100% | 100% | 100% | 100% | 100% | 100% |
| P127D | T9231 | 0.1 | | 108% | 110% | 103% | 103% | 99% | 101% | 102% |
| P127E | T9231 | 0.2 | | 111% | 116% | 104% | 103% | 96% | 100% | 101% |
| P127F | T9231 | 0.3 | | 107% | 115% | 107% | 107% | 98% | 97% | 99% |
| N660 | N660 | | | 102% | 110% | 108% | 116% | 102% | 100% | 94% |
| P131A | T9245 | | | 100% | 100% | 100% | 100% | 100% | 100% | 100% |
| P131B | T9245 | 0.1 | | 107% | 107% | 101% | 103% | 101% | 100% | 99% |
| P131C | T9245 | 0.13 | | 109% | 108% | 99% | 100% | 98% | 98% | 99% |
| P131D | T9245 | 0.15 | | 111% | 113% | 101% | 101% | 98% | 99% | 100% |
| P131E | T9245 | 0.18 | | 103% | 107% | 104% | 104% | 99% | 98% | 99% |
| P131F | T9245 | 0.2 | | 105% | 108% | 103% | 94% | 89% | 97% | 96% |
| P131G | T9245 | 0.15 | | 108% | 111% | 103% | 98% | 95% | 97% | 93% |
| N660 | N660 | | | 104% | 112% | 108% | 114% | 104% | 99% | 95% |
| P132B | T9216 | | | 100% | 100% | 100% | 100% | 100% | 100% | 100% |
| P132D | T9216 | 0.05 | | 107% | 107% | 101% | 103% | 101% | 100% | 99% |
| P132E | T9216 | 0.1 | | 109% | 108% | 99% | 100% | 98% | 98% | 99% |
| P132F | T9216 | 0.3 | | 111% | 113% | 101% | 101% | 98% | 99% | 100% |
| N660 | N660 | | | 107% | 112% | 105% | 114% | 99% | 102% | 93% |
| P133A | Blend | | | 100% | 100% | 100% | 100% | 100% | 100% | 100% |
| P133C | Blend | 0.1 | | 102% | 100% | 99% | 91% | 90% | 100% | 97% |
| P133D | Blend | 0.3 | | 105% | 104% | 99% | 95% | 96% | 99% | 93% |
| N660 | N660 | | | 101% | 105% | 104% | 110% | 105% | 101% | 95% |

### Example 10: Inner Liner BINRI01

TABLE 22
Compound Formulation (Inner Liner BINRI01)

| | | | |
|---|---|---|---|
| Ingredient | Detail | PHR | Wt. % |

Pass 1, Master Batch (MB)

| | | | |
|---|---|---|---|
| BIIR | Exxon Bromobutyl 2222; polymer | 80 | 43.76 |
| NR | Natural Rubber SIR 20; polymer | 20 | 10.94 |
| Naphthenic Oil | Plasticizer ln; process oil, | 8 | 4.38 |
| | processing aid | | |
| Blk | Carbon Black; filler | 60 | 32.82 |
| Hydrocarbon | Proaid AC-740; tackifying resin, | 7 | 3.83 |
| Resin | processing aid | | |
| Phenolic Resin | SP 1068 (P-90) Resin; curative, | 4 | 2.19 |
| | tackifying resin | | |
| Stearic Acid | Stearic Acid-Rubbergrade; activator, | 1 | 0.55 |
| | processing aid | | |

| | | |
|---|---|---|
| Total | 180 | — |

Pass 2

| | | | |
|---|---|---|---|
| MB | Master Batch | 180 | — |
| Zinc | Zinc Oxide RGT-M; activator, curative | 1 | 0.55 |
| Sulfur | Rubbermakers sulfur; curative | 0.5 | 0.27 |
| Accel | MBTS; accelerator | 1.3 | 0.71 |

| | | |
|---|---|---|
| Total | 182.8 | 100.00 |

Summary of Mixing Steps. First Pass: add polymers (Exxon Bromobutyl 2222 and SIR 20) and hydrocarbon resin (Proaid AC-740); mix 30 seconds. Add carbon black; mix 60 seconds. Add naphthenic oil, phenolic resin, and stearic acid; mix 30 seconds. Include two ram clean-out steps at 30 seconds each; mix until drop temperature of 125° C. is reached. Second Pass: add first pass mix plus zinc oxide, sulfur, and MBTS; mix until drop temperature of 105° C. is reached.

TABLE 23
Material Composition and Mixing - First Pass

| Component | Weigh-Up 1^{st} Pass (g) |
|---|---|
| Exxon Bromobutyl 2222 | 600.0 |
| SIR20 Prime Rubber | 150.0 |
| Naphthenic Oil (Plasticizer ln) | 60.0 |
| Stearic Acid | 7.5 |
| Phenolic Resin Tackifier (SP 1068) | 30.0 |
| Proaid AC-740 | 52.5 |
| Carbon Black | 450.0 |
| Calculated Total | 1350.0 |

Detailed Mixing Steps. Banbury First Pass: starting temperature 45° C. and starting RPM of 30. Add Proaid AC-740 and polymers (Exxon Bromobutyl 2222 and SIR 20); mix 30 seconds. While mixing proceeds, manually prepare thickened oil by pouring about 25% of the carbon black (CB) into the oil. Add dry CB (remaining about 75%) by pouring down the mixer throat; mix 60 seconds. Add naphthenic oil (oil thickened with about 25% of the CB). Add phenolic resin (SP1068) and stearic acid; mix 30 seconds. Clean ram; mix 25 seconds. Clean ram; mix at 90 RPM until a drop temperature of 125° C. is reached. Milling First Pass: make sure chiller unit is on and flowing 45° F. (7° C.) water through the rolls; mill gap gauge (a.k.a. mill roll gauge) is 1.2 mm to start.

TABLE 24
Material Composition and Mixing - Second Pass

| Component | Weigh-Up 2^{nd} Pass (g) |
|---|---|
| First pass non-productive mix | 1303.7 |
| Sulfur | 3.6 |
| MBTS | 9.4 |
| Zinc Oxide | 7.2 |
| Calculated Total | 1323.9 |

Banbury Second Pass: temperature 45° C. and starting RPM of 30. Add ingredients: add non-productive mix (first pass compound); sulfur, MBTS, zinc oxide. Lower ram; mix at 90 RPM until a drop temperature of 105° C. is reached. Milling Second Pass: chill the mill rolls via chiller set to 45° F. (7° C.). Start mill gap gauge at 1.2 mm for initial banding; set mill gap gauge to 0.8 mm for pig roll mixing. Starting from one edge, make continuous angled cut in the rubber while rolling it (a.k.a. make “pig roll”) and, when the rubber is off the mill, feed pig roll end-wise back into the mill. Make 10 such pig rolls, alternating starting edges; increase mill gap gauge to 1.2 mm for final sheeting out.

Rubber Properties. The BINRI01 inner liner formulation was mixed with pelletized plasma pyrolysis carbon black and furnace carbon black and used to compare rubber properties. All rubber samples (denoted “P” and “N” based on plasma pyrolysis carbon black and furnace carbon black, respectively) contain 0.3% lignosulfonate to establish a baseline. This enables the assessment of how additional active ingredients, such as DTC (e.g., sodium diethyldithiocarbamate) and sulfur, will perform in the ply formulation. The sulfur was supplied as a basic colloidal sulfur suspension with sulfur colloidal particles in the size range of 1-10 microns. The furnace carbon black samples were acquired from a supplier; while the exact binder loading is unknown, it is common to use lignosulfonate as a binder during the pelletization process. The plasma pyrolysis carbon black samples were made by Monolith Materials, Inc.

TABLE 25
Rubber Properties (Process)
Cure: 160° C. for T95 + 2 min in BINRI01

| Sample ID | CBID | DTC | Sulfur | ML | MH | TS1 | TS2 | T25 | T95 | ML 1 + 4 |
|---|---|---|---|---|---|---|---|---|---|---|
| P073B | T8974 | | | 100% | 100% | 100% | 100% | 100% | 100% | 100% |
| P073E | T8974 | 0.15 | | 104% | 106% | 95% | 96% | 97% | 95% | 104% |
| P073F | T8974 | 0.3 | | 104% | 109% | 91% | 91% | 95% | 94% | 103% |
| P073H | T8974 | 0.3 | 0.2 | 106% | 115% | 77% | 78% | 82% | 85% | 105% |
| P073I | T8974 | | 1 | 106% | 117% | 76% | 75% | 83% | 80% | 102% |
| P073J | T8974 | 0.3 | 1 | 106% | 124% | 62% | 61% | 69% | 71% | 103% |
| N772 | N772 | | | 100% | 102% | 95% | 96% | 97% | 99% | 95% |
| P133A | Blend | | | 100% | 100% | 100% | 100% | 100% | 100% | 100% |
| P133C | Blend | 0.1 | | 105% | 102% | 103% | 100% | 102% | 97% | 102% |
| P133D | Blend | 0.3 | | 107% | 106% | 94% | 92% | 94% | 98% | 103% |
| N660 | N660 | | | 99% | 94% | 105% | 103% | 101% | 107% | 97% |

TABLE 26
Rubber Properties (Properties)
Cure: 160° C. for T95 + 2 min in BINRI01

| Sample ID | CBID | DTC | Sulfur | M100 | M300 | M300/M100 | Tensile | Elongation | Shore A | Dispersion |
|---|---|---|---|---|---|---|---|---|---|---|
| P073B | T8974 | | | 100% | 100% | 100% | 100% | 100% | 100% | 100% |
| P073E | T8974 | 0.15 | | 101% | 106% | 105% | 95% | 94% | 97% | 101% |
| P073F | T8974 | 0.3 | | 105% | 111% | 106% | 104% | 97% | 99% | 101% |
| P073H | T8974 | 0.3 | 0.2 | 109% | 121% | 111% | 107% | 93% | 100% | 102% |
| P073I | T8974 | | 1 | 111% | 126% | 113% | 105% | 91% | 101% | 102% |
| P073J | T8974 | 0.3 | 1 | 115% | 128% | 111% | 105% | 90% | 102% | 100% |
| N772 | N772 | | | 100% | 106% | 105% | 103% | 99% | 99% | 97% |
| P133A | Blend | | | 100% | 100% | 100% | 100% | 100% | 100% | 100% |
| P133C | Blend | 0.1 | | 104% | 108% | 104% | 104% | 98% | 98% | 98% |
| P133D | Blend | 0.3 | | 108% | 113% | 105% | 97% | 89% | 98% | 99% |
| N660 | N660 | | | 100% | 103% | 104% | 108% | 104% | 98% | 98% |

Summary—Rubber Properties (Process). As can be seen in the rubber properties (process) data for Examples 6-10 above, the result of adding water soluble sulfur active species of the present disclosure, with and without elemental colloidal sulfur, results in an increase in scorch and a reduction in TS1 and TS2. In some instances, this decrease in TS1 and TS2 is up to 40% compared to the corresponding baseline sample. This is offset in the non-bromobutyl formulations by the fact that the unmodified plasma carbon black, when compounded into rubber, results in a substantially decreased scorch time (TS1 and TS2). In the NRESP01 of Example 6, BRNRW01 of Example 7, and ESD01 (ASTM D3191) of Example 8, it can easily be observed that the water soluble sulfur active species of the present disclosure (e.g., DTC or others) can be used to better match the cure curves, scorch and cure times of corresponding formulations containing reference furnace black, as evidenced in the data in the TS1, TS2, T25, T95, and ML 1+4 (Mooney) columns of Tables 4-5, 11, and 15.

Summary—Rubber Properties (Properties). Among the most important cured rubber compound physical property parameters is the modulus at 300% elongation (M300), which is improved by the presence of water soluble sulfur active molecules on the surface of the plasma carbon black. The modulus at 100% elongation (M100) is the force required to pull the specimen to double its original length. The ultimate tensile (tensile) and the ultimate elongation (elongation) are within 10% of corresponding formulations containing reference furnace black in almost all instances and not significantly different from the baseline plasma carbon black with only lignosulfonate present. Shore A hardness also is almost completely unchanged when the surface of the carbon particle is decorated with water soluble sulfur active species. Dispersion (measured by Dispergrader) is also unchanged whether or not the plasma carbon black possesses the water soluble sulfur active species at the surface or not. It is remarkable and surprising that both the M300 can be changed and the cure parameters such as TS1, TS2, and T95 can be changed while keeping almost all other parameters the same or similar to the baseline (untreated) plasma carbon black.

Carbon Black Properties. Measured properties of the carbon black samples used in the examples above are shown in Tables 27-28 below. In Table 28, values greater than 100% for carbon (C %) are an artifact of the measurement, which has a relative deviation of +/−2. Values have been reduced to 100% in those instances.

TABLE 27
Carbon Black Properties
Carbon Black Physical Properties

| | | | | N₂SA | STSA | | | | |
|---|---|---|---|---|---|---|---|---|---|
| Sample ID | CBID | DTC | Sulfur | (m²/g) | (m²/g) | OAN | COAN | d(002) | Lc |
| P084A | T9556 | | | 26.2 | 28.8 | 86.0 | 80.2 | | |
| P084H | T9556 | 0.2 | 0.2 | 25.7 | 28.0 | 91.3 | 83.6 | | |
| P084I | T9556 | 0.2 | 0.5 | 25.5 | 27.7 | 90.1 | 83.4 | | |
| P084J | T9556 | 0.2 | 0.2 | 26.0 | 28.5 | 89.8 | 83.3 | | |
| P084K | T9556 | 0.2 | 0.5 | 25.5 | 27.6 | 88.9 | 82.1 | | |
| P088B | T9841 | | | 28.4 | 31.0 | 88.8 | | | |
| P088F | T9841 | 0.3 | 0.2 | 27.1 | 29.3 | 89.2 | | | |
| P092B | T9700 | | | 27.2 | 30.2 | 90.4 | | | |
| P092F | T9700 | 0.3 | 0.3 | 26.3 | 29.0 | 87.3 | | | |
| P093B | T9847 | | | 28.2 | 30.9 | 94.0 | 89.9 | | |
| P093F | T9847 | 0.3 | 0.3 | 27.7 | 30.4 | 92.3 | | | |
| P105B | T9847 | | | 28.8 | 31.8 | 96.5 | | | |
| P105D | T9847 | 0.3 | 0.3 | 26.7 | 29.5 | 96.3 | | | |
| P126B | T9217 | | | 36.9 | 40.8 | 92.6 | | | |
| P126G | T9217 | 0.3 | | 36.2 | 40.1 | 92.0 | | | |
| P127B | T9231 | | | 36.3 | 40.6 | 93.5 | | | |
| P127D | T9231 | 0.1 | | 36.5 | 40.7 | 92.7 | | | |
| P127E | T9231 | 0.2 | | 36.3 | 40.3 | 92.3 | | | |
| P127F | T9231 | 0.3 | | 36.3 | 40.4 | 92.6 | | | |
| P133A | Blend | | | 37.3 | 41.2 | 94.0 | 84.6 | 0.346 | 3.723 |
| P133C | Blend | 0.1 | | 37.3 | 41.2 | 93.5 | 87.7 | | |
| P133D | Blend | 0.3 | | 37.2 | 41.2 | 91.2 | 86.8 | | |
| N660 | N660 | | | 36.3 | 36.1 | 91.4 | 73.9 | 0.4 | 1.5 |

TABLE 28
Carbon Black Properties (continued)
Carbon Black Physical Properties

| Sample | | | | | | | | |
|---|---|---|---|---|---|---|---|---|
| ID | CBID | DTC | Sulfur | O % | N % | H % | S % | C % |
| P084A | T9556 | | | 0.25 | 0.03 | 0.06 | 0.02 | 98.68 |
| P084H | T9556 | 0.2 | 0.2 | | | | | |
| P084I | T9556 | 0.2 | 0.5 | 0.31 | 0.04 | 0.07 | 0.66 | 98.98 |
| P084J | T9556 | 0.2 | 0.2 | | | | | |
| P084K | T9556 | 0.2 | 0.5 | 0.34 | 0.04 | 0.07 | 0.61 | 98.28 |
| P088B | T9841 | | | | | | 0.02 | |
| P088F | T9841 | 0.3 | 0.2 | | | | 0.45 | |
| P092B | T9700 | | | | | | 0.02 | |
| P092F | T9700 | 0.3 | 0.3 | | | | 0.34 | |
| P093B | T9847 | | | 0.24 | 0.04 | 0.06 | 0.02 | |
| P093F | T9847 | 0.3 | 0.3 | 0.40 | 0.06 | 0.08 | 0.37 | |
| P105B | T9847 | | | 0.22 | 0.05 | 0.06 | 0.02 | 99.48 |
| P105D | T9847 | 0.3 | 0.3 | 0.32 | 0.07 | 0.08 | 0.48 | 98.73 |
| P126B | T9217 | | | 0.28 | 0.05 | 0.07 | 0.02 | 100 |
| P126G | T9217 | 0.3 | | 0.36 | 0.06 | 0.09 | 0.16 | 100 |
| P127B | T9231 | | | 0.26 | 0.04 | 0.07 | 0.02 | 100 |
| P127D | T9231 | 0.1 | | 0.30 | 0.05 | 0.08 | 0.06 | 100 |
| P127E | T9231 | 0.2 | | 0.31 | 0.06 | 0.09 | 0.11 | 100 |
| P127F | T9231 | 0.3 | | 0.34 | 0.06 | 0.09 | 0.16 | 100 |
| P133A | Blend | | | 0.29 | 0.05 | 0.07 | 0.02 | 98.92 |
| P133C | Blend | 0.1 | | 0.27 | 0.05 | 0.07 | 0.07 | 98.62 |
| P133D | Blend | 0.3 | | 0.31 | 0.06 | 0.08 | 0.15 | 98.46 |
| N660 | N660 | | | 0.64 | 0.11 | 0.33 | 2.10 | 96.00 |

Further variations and modifications of the present disclosure will be apparent to those skilled in the art and are intended to be encompassed by the claims appended hereto. While embodiments of the present disclosure are shown and described herein, such embodiments are provided by way of example only. It is not intended for the scope of the present disclosure to be limited by the specific examples provided within the specification. The descriptions and illustrations of the embodiments herein are not meant to be construed in a limiting sense. Numerous variations, changes, and substitutions may occur to those skilled in the art without departing from the present disclosure. It should be understood that no aspect of the present disclosure is limited to the specific depictions, configurations, relative proportions, examples, or results set forth herein, which depend upon a variety of conditions and variables. It should be understood that various alternatives to the embodiments described herein may be employed and that the present disclosure shall also cover any such alternatives, modifications, variations or equivalents. It is intended that the following claims define the scope of the invention and that methods and structures within the scope of these claims and their equivalents be covered thereby.

1. A carbon black pellet comprising carbon particles decorated with one or more water soluble sulfur active species after the carbon particles are degassed.

2. The carbon black pellet of claim 1, wherein the carbon particles are decorated at, in, or after a pelletizer.

3. The carbon black pellet of claim 1, wherein the one or more water soluble sulfur active species has (i) a water solubility greater than or equal to about 20 grams per liter (g/L) and (ii) at least one carbon atom, at least one hydrogen atom, and at least one sulfur atom in a molecule.

4. The carbon black pellet of claim 3, wherein compounding the carbon black pellet with an elastomer into an elastomer compound increases a modulus at 300% elongation (M300) or a ratio of a modulus at 300% elongation to a modulus at 100% elongation (M300/M100) of the elastomer compound by at least about 5% compared to a reference M300 or a reference M300/M100, respectively, of a reference elastomer compound, wherein the reference elastomer compound contains a reference carbon black pellet of a same preparation except without decorating carbon particles of the reference carbon black pellet with the one or more water soluble sulfur active species.

5. The carbon black pellet of claim 1, wherein levels of the one or more water soluble sulfur active species on the decorated carbon particles are between 0.05% and 1% by mass.

6. The carbon black pellet of claim 1, wherein the one or more water soluble sulfur active species comprises a dithiocarbamate, a thiocarbamate, a xanthate, a thiourea, a thiocarbamide, a thiuram, a functionalized lignosulfonate, a sodium mercaptobenzothiazole, 5-amino-2-mercaptobenzimidazole or its related compounds, or any combination thereof.

7. The carbon black pellet of claim 6, wherein the one or more water soluble sulfur active species comprises the dithiocarbamate, the xanthate, or the functionalized lignosulfonate.

8. The carbon black pellet of claim 1, wherein, before the carbon particles are degassed, the carbon particles are generated in a plasma process.

9. The carbon black pellet of claim 1, further comprising elemental sulfur supplied in colloidal form decorated on the surface thereof.

10. The carbon black pellet of claim 1, wherein the carbon particles are decorated with a cure retarder, an amine, or both, with or in addition to the one or more water soluble sulfur active species after the carbon particles are degassed.

11. A composite comprising an elastomer and the carbon black pellet of claim 1.

12. A method comprising adding, after degassing and before a dryer, one or more water soluble sulfur active species to carbon black particles to form the carbon black pellet of claim 1.

13. Treated carbon particles having on their surface a water soluble sulfur active species such that, when the treated carbon particles are compounded with an elastomer into an elastomer compound, the elastomer compound has a modulus at 300% elongation (M300) that is higher than a reference M300 of a reference elastomer compound, by a value greater than ten (10) times a percentage loading of the water soluble sulfur active species on the treated carbon particles, wherein the reference elastomer compound comprises reference carbon particles that are of a same preparation as the treated carbon particles except the reference carbon particles have no water soluble sulfur active species on a surface thereof.

14. The treated carbon particles of claim 13, wherein the surface of the treated carbon particles has at least one selected from: an oxygen level of less than 0.5% by mass, a nitrogen level of less than 0.09% by mass, a hydrogen level of less than 0.25% by mass, and a sulfur level and less than 0.5% by mass.

15. The treated carbon particles of claim 13, wherein the elastomer compound has a scorch time (TS1) that is lower than a reference TS1 of the reference elastomer compound, by a value greater than or equal to thirty (30) times the percentage loading of the water soluble sulfur active species on the treated carbon particles.

16. The treated carbon particles of claim 13, wherein scorch times (TS1 and TS2) of the elastomer compound comprising the treated carbon particles are decreased by more than 10% but less than 40% compared to the reference elastomer compound.

17. The treated carbon particles of claim 13, wherein a loading of the water soluble sulfur active species is between 0.05% and 0.5% by mass.

18. The treated carbon particles of claim 13, further comprising elemental sulfur on the surface thereof.

19. A method for improving a carbon particle for use in an elastomer compound, the method comprising:
(a) reacting a liquid hydrocarbon mixture with carbon disulfide (CS₂), wherein the liquid hydrocarbon mixture (i) has an average molecular weight of at least 150 g/mol and (ii) comprises one or more polycyclic aromatic hydrocarbons (PAHs) functionalized with oxygen, nitrogen, or both in an individual or combined concentration of at least 0.5% by weight;
(b) thereby generating a dithiocarbamate or a xanthate; and
(c) decorating a surface of the carbon particle with one or more of the dithiocarbamate or the xanthate.

20. The method of claim 19, wherein the liquid hydrocarbon mixture comprises one or more of carbon black oil (CBO), aminopyrene, or alcohol-functionalized pyrene.
